(19) United States
(12) Patent Application Publication
(10) Pub. No.: US 2004/0091843 A1
(43) Pub. Date: May 13, 2004

(54) Menu generator, system and methods for generating clinical menus

(76) Inventors: Todd M. Albro, Vancouver, WA (US); Scott D. Murdoch, Bothell, WA (US); Eugene Dwayne Garrett, Vancouver, WA (US); William C. Eklund, Portland, OR (US); Caleb Skinner, Beaverton, OR (US); Shannon R. Madsen, Saint Paul, MN (US)

Correspondence Address: Fields IP, PS, Suite 218, 1014 Franklin Street, Vancouver, WA, 98660, US

(21) Appl. No.: 10/292,973

(22) Filed: Nov. 12, 2002

(51) Int. Cl. G09B 19/00

(52) U.S. Cl. 434/127

(57) ABSTRACT

A method to generate a clinical menu may select a food item from a database. For this method an attribute of a clinical record may be used to influence the food selection. In a particular example, the attribute may serve as an index to assist indexing of the database. The attribute may be based on the level of micronutrients, level of a macronutrients, health condition or food preference of a patent. In another embodiment, the nutritional elements of a food item may be compared to guidelines of a patient, and a selection of the food item may be made dependent on the comparison results. In accordance with a further embodiment of the present invention, a system may comprise a host operable to access food and client databases, and a client station in communication with the host. A machine-readable storage media may store a sequence of instructions which, when executed by the host, cause it to display and operate an interactive window in the client station to establish an individual identity. The information of the individual may be used to retrieve clinical criteria from a patient database. The instructions may further be operable to influence selection of food items from a food database with preferences dependent on the clinical criteria retrieved.

### COPYRIGHT NOTICE

A portion of this disclosure contains materials that are subject to copyright protection. The copyright owner has no objection to the facsimile reproduction by any one of the patent disclosure, as it appears in the Patent and Trademark Office patents, files or records, but otherwise reserves all copyright rights therein.

### BACKGROUND

This disclosure is related to menu synthesis and more particularly to methods and generators for generating clinical menus. The systems and tools of the various embodiments may include workstations, network devices, database systems and methods to assist a dietitian or client create a clinical menu.

Conventionally, the creation of clinical menus has required lengthy manual analysis by a dietitian to piece together food items into meals for a clinical menu suited to a patient's clinical criteria. The dietitian may understand an array of food items from their previous dealings and experience, which may be integrated into the clinical menu. The crafting of these clinical menus has conventionally been performed through manual iterative procedures and has been heavily dependent on the experience and knowledge base of dietitians.

In these conventional processes, for example, an initial combination of foods and meals of a menu cycle may be analyzed for nutritional breakdowns and manually reviewed to verify that they meet clinical guidelines of a patient. If a dietitian should see that their nutritional breakdown should miss the clinical criteria, then the dietitian may choose a food item of the previously constructed menu that may be adjusted or replaced with a new food item. The new combination may more accurately meet the clinical criteria.

This manual method of menu creation depends on the dietitian's knowledge and understanding of foods, the nutritional make-up of the foods and their similarity to other foods. If the dietitian should possess superb understanding, then the number of iterations for obtaining a clinical menu may be kept few. Alternatively and more typically, the dietitian may perform several iterations before establishing a clinical menu that may meet a desired goal.

Even so, these conventional and manual procedures, even for dietitians of superb knowledge, often result in rigid menus based on the dietitian's working familiarity. Such menus may be described as rigid given that they may lack incorporation of food preferences, customs, lifestyle or culture of the patient. Additionally, should the patient wish to modify their assigned menu, the time-consuming and costly manual processes of the dietitian may again need to be performed to verify adjustments and conformity with clinical needs of the patient.

In another conventional case, the patient may use a food exchange list in an effort to construct alternate meals in their menu. The exchange list may show foods and meals that may satisfy some pre-determined nutrient content. The different options for meals and categories allow the patient to select meals from the food exchange list to lend a certain amount of variety as available by the exchange. But such exchange list may satisfy only a few main requirements, which may leave the rest of the requirements to be either ignored or implemented within the limitations of the dietitian and within their allotted time constraints.

Furthermore, because of a dietitian's limited resources and time available for creating clinical menus and food exchange lists, the menu and/or exchange list may show a limited number of items and variety. The dietitian may also lack familiarity of foods that may be associated with a patient's cultural background and customs, and may thus feel obligated to allocate menus of known conformity. The client or patient may not readily appreciate these needs of the exchange list and may not enjoy the limited items offered by the exchange list. In the end, the patient may feel less inclined to follow the seemingly sterile “clinical” menu.

### SUMMARY

In accordance with an embodiment of the present invention, a clinical menu may be generated or synthesized with a tailoring to meet nutritional guidelines and lifestyle of a patient. The tailoring may be based upon maladies, preferences, customs and medical needs of the patient.

In one exemplary embodiment, a method of generating a clinical menu may select a food item from a database. For this embodiment, a clinical record of an individual may influence the selection.

In a further embodiment, an attribute of the clinical record may be identified and used to index the database. The selection may then pull a record of the database having a key matching the attribute index. For example, the attribute may be based on a level of a micronutrient, a level of a macronutrient, a health condition or eating pattern.

In another embodiment, the selecting and affecting may comprise determining nutritional elements associated with a food item in the data bank. The clinical record for the individual may be used to establish nutritional guidelines. The nutritional elements determined for the food item may be compared with the guidelines and the selection of the food item made dependent on the comparison results.

In accordance with a further embodiment of the present invention, a system may comprise a host station operable to access food and client databases. A client station may be configurable to communicate with the host. A machine readable storage media may store a sequence of instructions and be in communication with the host, which when executed thereby, cause it to display and operate an interactive window in the client station to prompt and obtain information for an individual. The information of the individual may be used to retrieve clinical criteria from a patient database. The instructions may further be operable to influence selection of food items from a food database dependent on the clinical criteria retrieved.

In a particular exemplary embodiment, the client station may be operable to display and operate a dietitian window. The instructions, when executed by at least one of the host and the dietitian station, may further provide the dietitian window with prompts to formulate the clinical criteria of the patient. At least one of the dietitian station and the host may be further operable to store the clinical criteria formulated. The instructions, when further executed by at least one of the host and dietitian station, may cause a record for the patient and the clinical criteria to be stored in the patient database. In a further embodiment, the client station may comprise a dietitian station and a patient station and the instructions may be further operable to present the interactive window in both a display of the dietitian station and a display of the patient station.

### BRIEF DESCRIPTION OF THE DRAWINGS

Subject matter of embodiments of the present invention and methods of operation may be further understood by reference to the following detailed description when read with reference to the accompanying drawings, in which:

FIG. 1 is a simplified relationship diagram with a plurality of modules that may be associated with menu generation and useful to assist an understanding of an embodiment of the present invention.

FIG. 2 is a simplified overview of an Entity-Relationship model for an inter-relationship database structure for an embodiment of the present invention.

FIG. 3 is schematic view of a display with an example of an interactive window for an embodiment of the present invention that may be used to obtain attributes for a patient profile.

FIG. 4 is an example of an interactive window in a display for an embodiment of the present invention that may be used to characterize activities of a patient.

FIG. 5 is an example of an interactive window in a display for an embodiment of the present invention that may be used to establish macro nutrient guidelines for a patient.

FIG. 6 is an example of an interactive window in a display for an embodiment of the present invention that may be used to outline micro nutrient criteria for a patient.

FIG. 7A is an example of an interactive window in a display for an embodiment of the present invention that may be used to define a meal pattern for a patient.

FIG. 7B is an example of an interactive window in a display for another embodiment of the present invention that may be used to define an alternative meal pattern for a patient.

FIG. 7C is an example of an interactive window in a display for an embodiment of the present invention that may be used to define meal pattern preferences for a patient.

FIG. 7D is an example of an interactive window in a display for an embodiment of the present invention that may be used to define preparation preferences within a menu for a patient.

FIG. 7E is an example of an interactive window in a display for an embodiment of the present invention that may be used to define a meal structures for a patient.

FIG. 7F is an example of an interactive window in a display for another embodiment of the present invention that may be used to set forth favorite foods for a patient.

FIG. 7G is an example of an interactive window in a display for another embodiment of the present invention that may be used to prescribe foods for a patient.

FIG. 8 is an example of an interactive window for an embodiment of the present invention that may be used to define or edit categories and components of various meals for a clinical menu.

FIG. 9A is an example of an interactive window in a display for an embodiment of the present invention that may be used to define or edit food preferences of a patient.

FIG. 9B is an example of an interactive window in a display for another embodiment of the present invention that may be used to define or edit food preferences of a patient.

FIG. 10A is an example of a window in a display for an embodiment of the present invention that may be used to present a clinical menu.

FIG. 10B is an example of a window in a display for an embodiment of the present invention that may be used to present an exchange list to a clinical menu.

FIG. 11 is a simplified flow chart illustrating an example of a method to generate a clinical menu in accordance with one embodiment of the present invention.

FIG. 12 is a schematic diagram of a system to generate a clinical menu in accordance with an embodiment of the present invention.

FIG. 13 is a schematic diagram illustrating an example of a machine-readable storage medium comprising a sequence of instructions to implement an embodiment of clinical menu generation in accordance with an embodiment of the present invention.

### DESCRIPTION

For exemplary embodiments of the present invention, the disclosure may characterize a client as an individual. Alternatively, the client may be referenced as a dietitian or a patient. In such context, patient may imply a relationship to a physician or dietitian.

Although, exemplary embodiments may described a patient and/or dietitian; it may be understood that certain embodiments may allow use by individuals other than “patients” and “dietitians” of the strict interpretations. For example, in some embodiments, a client may interact individually with a menu generation server. In other embodiments; a client may interact with a general nutritionist, clinician or alternative administrator of the nutritional menu servicing. Accordingly, the interpretation of “patient” and “dietitian” for these embodiments may be understood to include individuals of more generic characterization.

### Integrated Modules

In accordance with an embodiment of the present invention, referencing FIG. 1, clinical menu generator 10 may be described as employing a plurality of modules: e.g., setup 20, synthesis 30 and/or adjustment 40. Setup module 20 may service a domain of menu generator 10 to gather information of patient(s) and to structure attributes of clinical criteria for use in menu synthesis. The setup module may establish or configure avenues into databases or regions of databases from which information may be obtained to assist synthesis and/or adjustment modules 30,40 during the creation of clinical menus. Further description of exemplary databases and indexing setups will be described more fully herein below.

A primary element of menu generator 10 may comprise synthesis module 30. Synthesis module 30 may pull information and food items from select databases and regions of the databases to be made selectable in accordance with their configurations or definitions as may have been previously established by setup module 20. The food items may be pulled from the databases to fill meals and categories within a menu cycle. The slots to be filled—e.g., the meals, categories and menu cycle—may have also been pre-designated by setup module 20.

In one embodiment, synthesis module 30 may run algorithms to automatically analyze foods either alone or collectively within meals as the slots for a menu are filled. Dependent on the analysis, adjustments may be made to particular meals or food items to assure selections to meet clinical criteria pre-established by the setup.

Adjustment module 40 may comprise a portion integrated with synthesis module 30 to assist analysis of an initial meal. The adjustment module may obtain analysis and identification of food items, which may be adjusted to tailor a nutritional makeup into closer conformity with clinical criteria of a patient. For example, the adjustment module may analyze a meal and determine a need for more/less protein. An egg serving of the meal may be identified with a high protein concentration, which could make the egg serving a good candidate to affect changes in protein levels for the meal. The adjustment module may then increase/decrease a portion of the egg serving to add/reduce protein in the meal. After increasing/decreasing the portion of the egg serving, the adjustment and synthesis modules may again analyze the meal to determine the nutritional conformity of the various elements, including the carbohydrates and fats.

The adjustment module may comprise other sub-modules substantially separate from synthesis module 30. For example, these separate sub-modules of the adjustment module may be operable to accept and process client requests for food replacement and/or for generation of completely different menus or meals. In another example, the adjustment module may be operable to accept a request to incorporate a snack into the menu on Sundays between a Breakfast (or Brunch) and Dinner. In this case, the sub-modules may call upon portions of the setup module 20 to update provisions for meal patterns of the patient so as to incorporate the snacking into Sundays.

As described, adjustment module 40 of menu creator 10 may comprise portions integral with the synthesis module and other portions integral with setup module 20. Additionally, the adjustment module may comprise portions substantially independent of the synthesis and setup modules. Similarly, the adjustment module may be viewed with portions integral with and portions separate from the setup module. Additionally, the setup module may comprise portions integral with the synthesis and adjustment modules. Accordingly, the simplified diagram of FIG. 1 portrays these various modules of menu creator 10 in shared, overlapping relationship.

### Database Structures

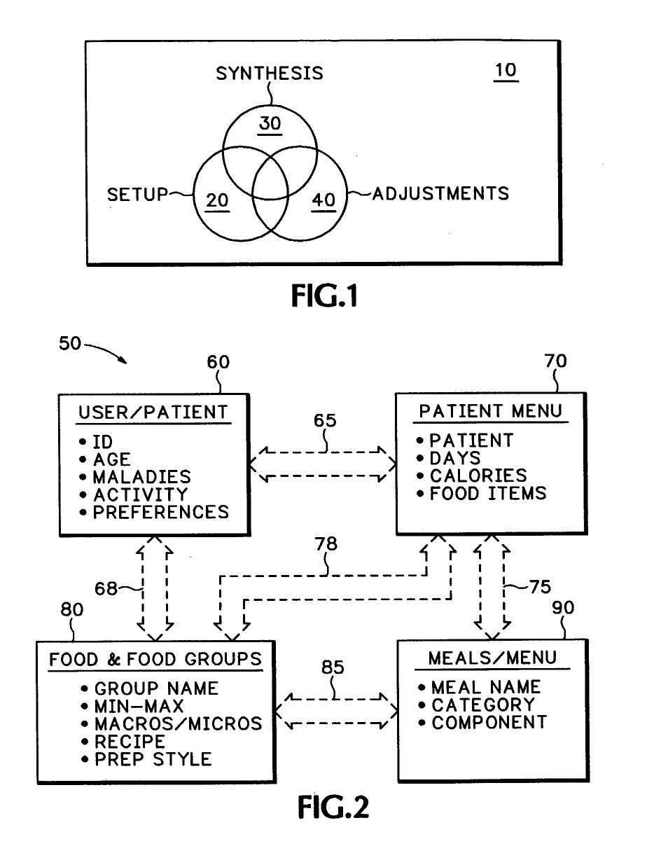

In an embodiment of the present invention, referencing FIG. 2, databases may be allocated to various types of information to assist the procedures of menu generation. These databases may be characterized and represented as separate entities of a relational database structure or model 50. For example, a high level, simplified relational database structure 50 in accordance with an embodiment of the present invention, may be represented as entities-relationships comprising USER/PATIENT entity 60 having respective relationships 65,68 to PATIENT MENU entity 70 and FOOD & FOOD GROUPS entity 80, respectively. Additionally, a relationship 78 may relate the PATIENT MENU ENTITY 70 and FOOD & FOOD GROUPS entity 80. MEALS/MENU entity 90 may be structured with relationships 75,85 to respective entities PATIENT MENU 70 and FOOD & FOOD GROUPS 80. These relationships may be one-to-one for respective attributes of the different entities, one-to-many, many-to-one or many-to-many as may appropriate for the grouping(s) of information of the data records.

For example, a given patient ID may be keyed to specific health profile records of USER/PATIENT entity 60 and indexed, via relationship 65, to a particular menu record of PATENT MENU entity 70 in accordance with patient ID indexes. Additionally, attributes such as a malady or preference characteristic of patient records of USER/PATIENT entity 60 may index via relationship 60 to specific portions such as low sodium type food records of FOOD & FOOD GROUPS entity 80. Additionally, food items of PATIENT MENU entity 70 may key into respective food records of FOOD & FOOD GROUPS entity 80 via food identifications through relationship 78. Analysis of a patient menu may thus query nutritional information from nutritional tables of entity 80 as index via respective food identities and indexes in PATIENT MENUS entity 70. Likewise, viable components to categories of meals may be designated for meals of MEAL/MENU entity 90 as made available to such categories across relationship 85. These, in-turn, may be employed when synthesizing meals and/or snack to fill records of the PATIENT MENU entity 70. Further details regarding the structures, composition and relationships of the different databases may be understood from the description of further embodiments herein below.

### System Model

In a particular example, a dietitian may meet with a patient of a special condition. A physician may have previously determined a special condition of the patient—e.g., diabetes, heart disease, renal disease or other malady—and thus referred the patient to the dietitian. Because of the patient's malady, the patient may require special dietary considerations to be administered by a dietitian.

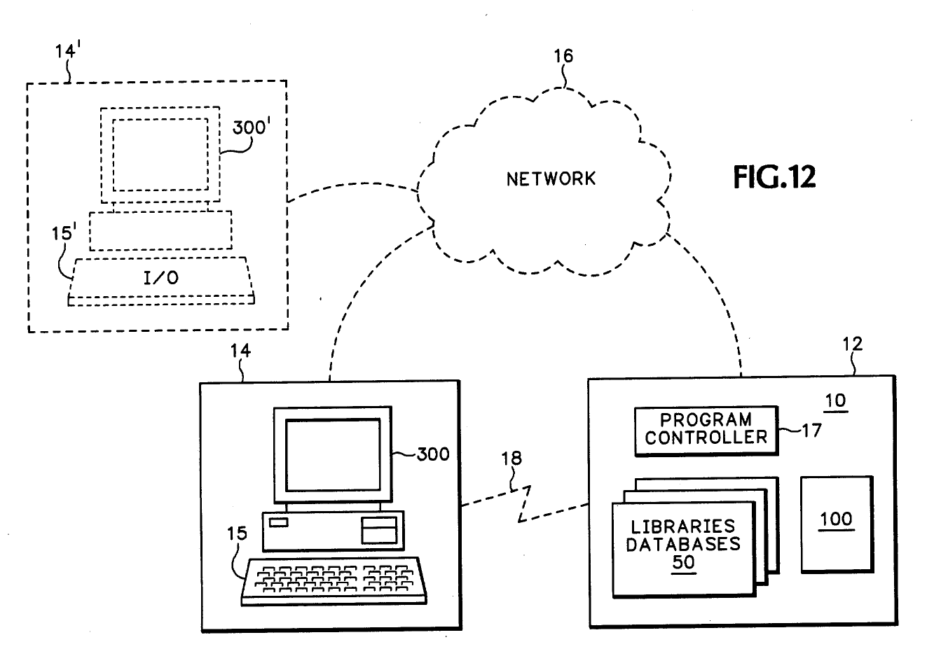

In one embodiment, the dietitian may begin by requesting a session with a menu generator. Referencing FIG. 12, the dietitian may operate an I/O device 15 with the aid of an interactive window at a display 300 of client station 14 to communicate with host 12. In accordance with one embodiment, the client station and host may form part of a single workstation, such as a personal computer system. In an alternative embodiment, client station 14 may be remote host 12 and may communicate with host through a local area network 18 or, alternatively, through network 16. In further embodiments, a patient may reside at a first station 14′ while a dietitian may reside at another station 14. Each client station may interact together through a common session served by web-server or host 12. As used hereinafter, client station 14 may be referenced alternatively as station.

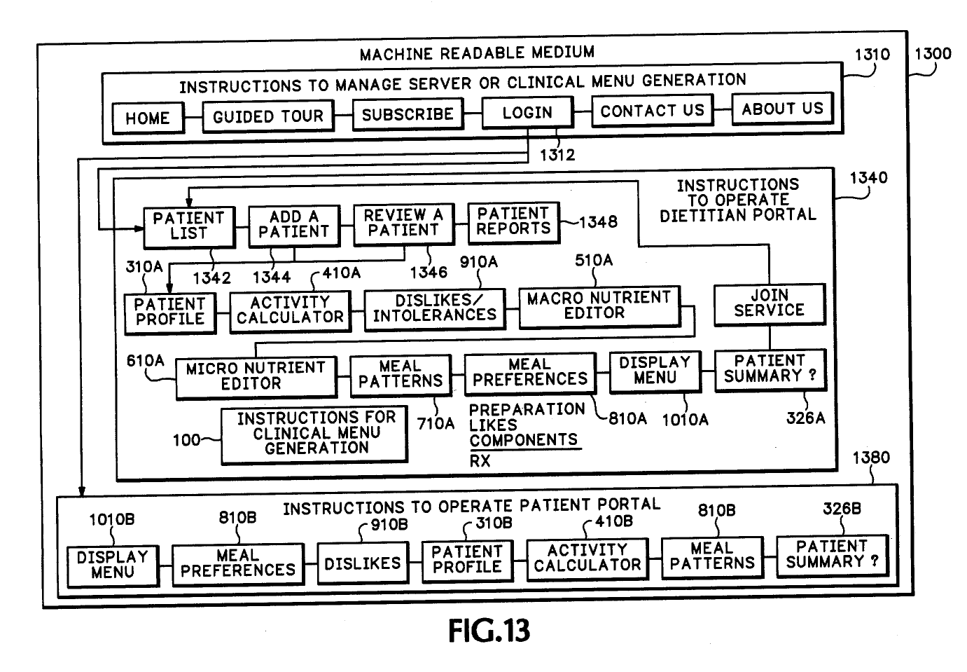

In these embodiments, further referencing FIGS. 12 and 13, host 12 may comprise program controller 17 operable to distribute (temporary) routines of instructions 100 and/or libraries 50 to assist clinical menu procedures at the remote station. For example, the program controller may send routines retrieved from machine-readable medium 1300 (referencing FIG. 13) to client station 14 for preference characteristic of patient records of USER/PATIENT entity 60 may index via relationship 60 to specific portions such as low sodium type food records of FOOD & FOOD GROUPS entity 80. Additionally, food items of PATIENT MENU entity 70 may key into respective food records of FOOD & FOOD GROUPS entity 80 via food identifications through relationship 78. Analysis of a patient menu may thus query nutritional information from nutritional tables of entity 80 as index via respective food identities and indexes in PATIENT MENUS entity 70. Likewise, viable components to categories of meals may be designated for meals of MEAL/MENU entity 90 as made available to such categories across relationship 85. These, in-turn, may be employed when synthesizing meals and/or snack to fill records of the PATIENT MENU entity 70. Further details regarding the structures, composition and relationships of the different databases may be understood from the description of further embodiments herein below.

### System Model

In a particular example, a dietitian may meet with a patient of a special condition. A physician may have previously determined a special condition of the patient—e.g., diabetes, heart disease, renal disease or other malady—and thus referred the patient to the dietitian. Because of the patient's malady, the patient may require special dietary considerations to be administered by a dietitian.

In one embodiment, the dietitian may begin by requesting a session with a menu generator. Referencing FIG. 12, the dietitian may operate an I/O device 15 with the aid of an interactive window at a display 300 of client station 14 to communicate with host 12. In accordance with one embodiment, the client station and host may form part of a single workstation, such as a personal computer system. In an alternative embodiment, client station 14 may be remote host 12 and may communicate with host through a local area network 18 or, alternatively, through network 16. In further embodiments, a patient may reside at a first station 14′ while a dietitian may reside at another station 14. Each client station may interact together through a common session served by web-server or host 12. As used hereinafter, client station 14 may be referenced alternatively as station.

In these embodiments, further referencing FIGS. 12 and 13, host 12 may comprise program controller 17 operable to distribute (temporary) routines of instructions 100 and/or libraries 50 to assist clinical menu procedures at the remote station. For example, the program controller may send routines retrieved from machine-readable medium 1300 (referencing FIG. 13) to client station 14 for establishing dietitian portal 1340 and may speed-up presentation of interactive windows (e.g., temporary templates) in display 300 of remote station 14. Such exemplary routines for the templates in the interactive windows may include some of those of FIG. 13, such as routines to establish Patient Profile 310A, Activity Calculations 410A, Dislikes or Intolerances 910A, MacroNutrient Edits 510A, MicroNutrient Edits 610A, Meal Patterns 710A, Meal Preferences 810A and/or Menu Display 1010A. Meal Preferences 810A may comprise modules to establishes preferences such as Ready-To-Serve, Dinning-Out, Previously Prepared or to be prepared from Select Recipes.

Depending upon pre-arranged license arrangements, the host may also serve remote station 14 a copy of portions of instructions 100 to enable menu synthesis to take place resident at remote station 14.

Further referencing FIGS. 12 and 13, in accordance with further embodiments of the present invention, host 12 may serve portions of instructions 100 to a second remote client station 14′ to allow a patient to interact individually with host 12 or, in an alternative embodiment, together with a dietitian at station 14. For this embodiment, the host may send routines of patient portal 1380 to patient client station 14′ to configure the remote station with an ability to readily present interactive windows to establish some of the set-up information. These routines may include those for presenting or establishing Menu Display 1010B, Meal Preferences 810B, Dislikes 910B, Patient Profile 310B, Activity Calculations 410B, Meal Patterns 810B and/or Patient Summary 326B.

In this embodiment, it may be understood that interconnect 18 and/or network 16 may comprise known or yet to be determined means of communicating instructions, data and/or information between host 12 and “client” station(s) 14,14′.

### Patient Profile

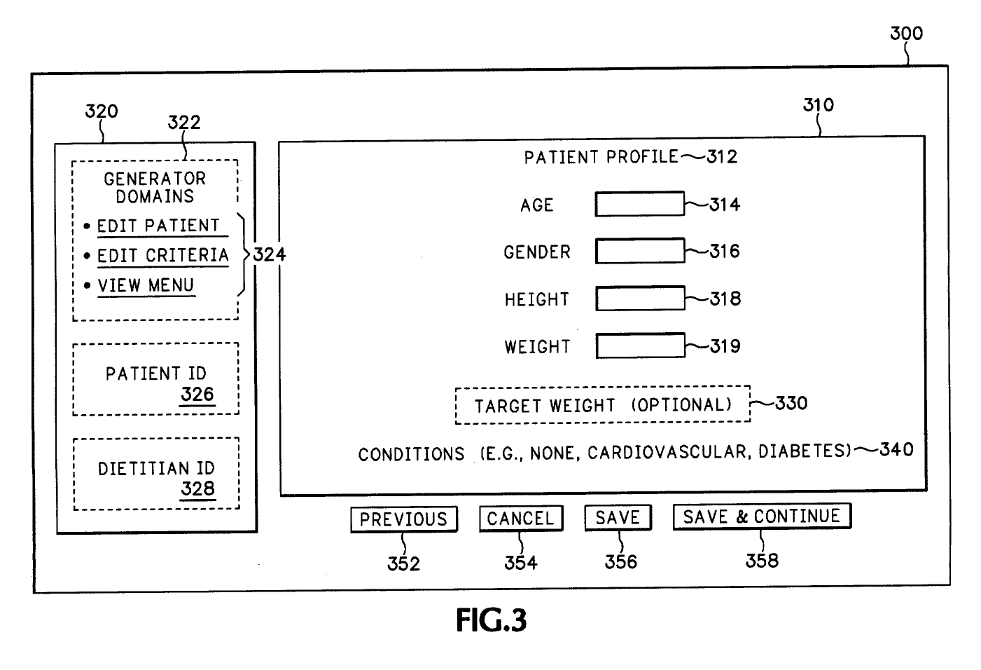

In an exemplary embodiment of the present invention, a dietitian may query a patient to determine information of the patient and to formulate a clinical record. Referencing FIGS. 13 and 3, a dietitian may be presented a Patient Profile template 310, as established by the portion 310A of the instructions of medium 1300 for configuring the Patient Profile interactive window. In a one embodiment, the window may provide values to a default profile of a healthy person. Attributes of the default patient profile 312 may then be modified by the dietitian to formulate, in accordance with determined medical characteristics or conditions, a clinical record specific to the patient identified 326. In this embodiment, patient identity information may be presented in a patient window 326 of display 300 and may enable a dietitian to check record-patient correlation and handling. Identity information of the patient may be retrieved/built into a pre-establish dietitian/patient database.

In another embodiment, a patient profile window 310 may be presented with attribute fields left empty. The dietitian may enter information for each field in accordance with the patient's characteristics. The dietitian may assess characteristics of the patient to determine and define the clinical record. The clinical record for the patient may then be stored in a patient database—e.g., of USER/PATIENT entity 60 of model 50 in FIG. 2.

In one embodiment of the present invention, the clinical record for a patient may be formulated to include information in various sub-categories such as health, activities, guidelines for macronutrients, guidelines for micronutrients, and meal patterns for the patient. Although disclosed in one embodiment with each of these sub-categories, it may be understood that alternative embodiments may comprise clinical records for the patient of fewer or additional clinical categories. For example, an additional category may comprise food preferences, dislikes, allergies or intolerances of the patient.

In a particular embodiment, the health characteristics for the clinical record of a patient may be determined or pre-established with information provided in fields of Patient Profile window 310. The window may be configured in a display 300/300′ (FIG. 12) and comprise an identification 312 such as Patient Profile. Fields 314,316,318,319 may query health information such as age, gender, height, and weight, respectively. Optionally, in a further embodiment, the window may further query a dietitian of identity 328 for information 340 concerning any maladies of the patient. Examples of maladies may include, e.g., a cardiovascular disease, immune support, diabetes, detoxification, etc.

In a further embodiment, Patient Profile window 310 may also provide field 330 to query a target weight that may be desired for the patient. These health attributes and information of the patient may be referenced collectively as part of the health profile of the patient.

In an exemplary embodiment, a patient database (e.g., Patient entity 60 of FIG. 2, or a particular database of library 50 of FIG. 12) may comprise clinical records to a plurality of patients. These patient records may be stored with indexes of dietitians. The indexes to specific dietitians may enable indexing and retrieval of these records of the patient database based upon the identity of a particular dietitian.

Records of the patient database may include information and/or encoding to assist security within the patient database. In a first example, a client may be prompted to provide information of their username and password before allowed permission to access the patient database. Additionally, a dietitian may build their records with another layer of security data as may be known or yet determined to provide security of the patient records.

### Activity Calculator

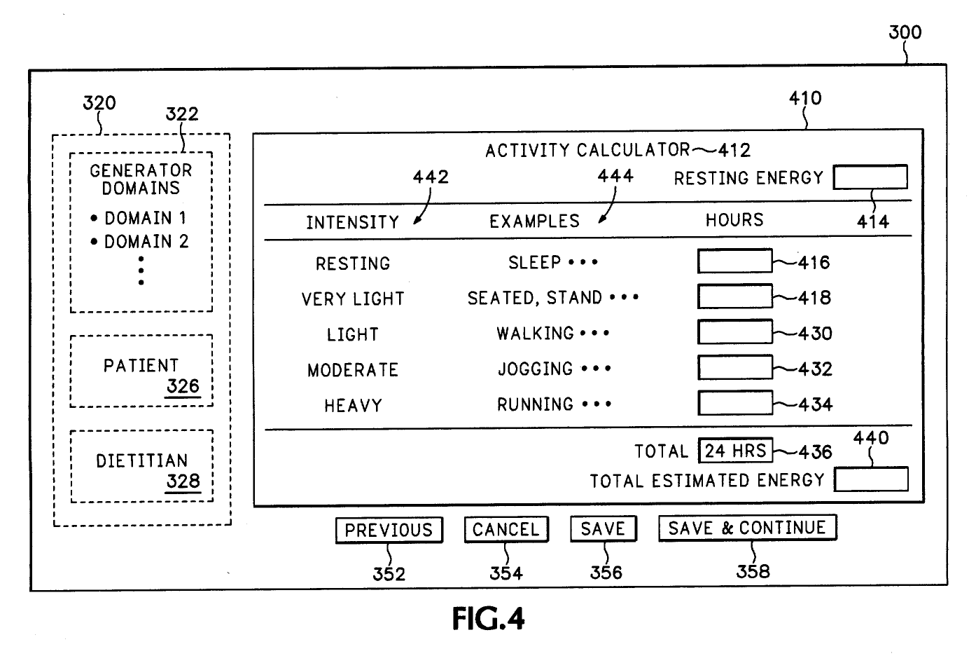

In further exemplary embodiments, a dietitian may also be presented an Activity Calculator window 410 such as that of FIG. 4. This setup provision of a menu generator may prompt the dietitian (or patient) with various fields to gather information of the patient's activities. In a particular embodiment, the dietitian may determine and enter information regarding the number of hours that a patient may spend in various levels of conduct. For example, the dietitian may fill and record activities as prompted by window 410 such as 12 hours of rest; 10 hours of very light activity; 0 hours of light activity; I hour of moderate activity; and 1 hour of heavy activity in respective fields 416,418,430,432,434. This template window 410 may present a window identification 412 of Activity Calculator or the like.

In this exemplary embodiment, further referencing FIG. 4, the window 410 may present the activities, descriptions and prompt fields in tabular form in columns 442,444 and 416-434 respectively. In this example, Resting Activities may be described as including sleeping, reclining, watching TV and may be assumed to provide a kilo-calorie burn rate of about 65 Kcal/hr for a 150 pound individual or 85 Kcal/hr for a 200 lb. individual.

Very Light activities may be described to include seated and standing activities, driving, laboratory work, typing, sewing, ironing, cooking, paying cards or musical instrument and the like to provide a kilo-calorie burn rate of about 100 Kcal/hr or 130 Kcal/hr for the 150 or 200 pound individual respectively.

Light activities may be described as including Walking on a level surface (2-3 mph), garage work, restaurant trades, house cleaning, child care, golf, sailing, table tennis, bicycling (<10 mph) and the like with kilo-calorie burn rates of about 160 and 210 Kcal/hr respectively for the 150 or 200 pound individual.

Moderate activities may comprise jogging (2.5-4 mph), weeding and hoeing, carrying a load, cycling, skiing, tennis, recreational dancing, bicycling at about 10-14 mph, swimming laps and similar activities of kilo-calorie burn rates of about 320 and 420 Kcal/hr respectively for the 150 or 200 lb. Individual.

Heavy activities may comprise Walking with a load uphill, basketball, climbing, football, soccer, running, bicycling faster than 14 mph, jogging less than 12 mph, aerobic dancing such as ballet or modern dancing, swimming laps quickly and similar activities of about 450 and 590 Kcal/hr burn rates for the respective 150 or 200 lb. individual.

Although having disclosed examples of different level activities for this embodiment, it may be understood that alternative embodiments may employ different groups and/or groupings of activities.

In this embodiment, further referencing FIG. 4, the Activity Calculator template window 410 may present a resting energy level for kilo-calories (or Kcal) in field 414. This starting level of kilo-calories may be determined in know manner dependent on the previously determined physical and health characteristics of the patient. The different types of activities may allow addition of calories to the starting level. The levels of exertion and associated durations may determine the amount of calorie additions. Summation of the rest and activity kilo-calories may provide an overall Total Estimated Energy, which may be presented in field 440. This may be referenced as a daily kilo-calorie budget for the patient.

Again, as in the previous template window, a navigation window 322 may provide gateways 324 to alternative domains of the menu generation, such as templates for some of the setup needs. The domains may comprise hyperlinks to establish gateways for setting-up/editing/presenting patient profile(s), patient information, patient reports, patient summary, activities, macro or micro nutritional guidelines, meal patterns, likes, dislikes or intolerances, food database information and/or categories and components. Additionally, the navigation icons 352,354,356,358 may allow progression through a given sequence of a set-up routine, synthesis and/or adjustment of the clinical menu creations. In a particular embodiment, these navigation icons may allow for advancement to a previous operation, cancellation of an existing provision, storage of entered information and/or storage and continuation to the next procedure respectively. Such navigation windows and icons may be present in various windows of the generation process.

### Likes, Dislikes and Intolerances and Rx

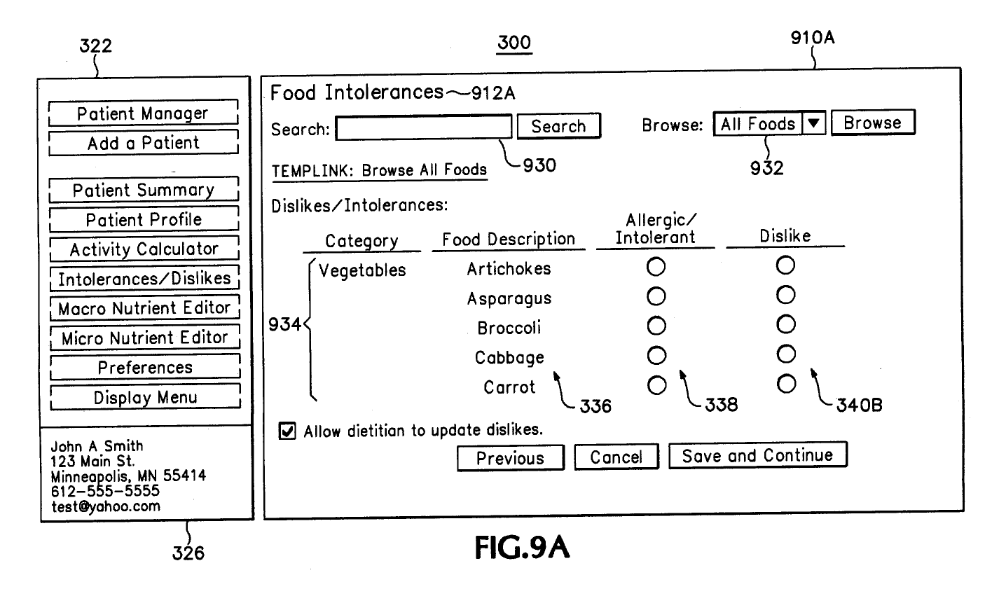

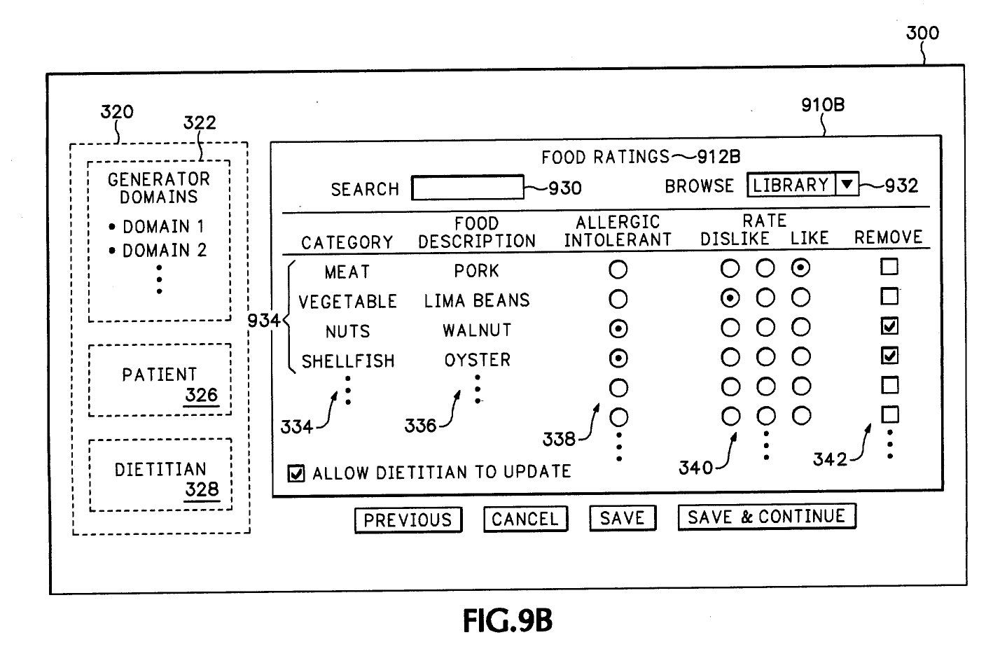

Continuing with an exemplary embodiment, a client and/or dietitian may also record particular foods that a patient may dislike or be allergic or intolerant. Referencing FIG. 9A, a Food Intolerance identification 912 may be presented in template window 910A. A search sub-window may allow entry and inquiry of a food item to attribute clinical significance 338 or 340B within a database and to associate with respective category and descriptions 334,336 for the patient's clinical criteria. In a further embodiment, a browsing sub-window 932 may allow a user to browse through food items of an available food databases.

In another embodiment, an interactive window may be presented to gather information of the food intolerances and dislikes at the same time as obtaining information of the patient's preferences. Referencing FIG. 9B, a Food Rating identification 912 may be presented in template window 910. Sub-windows 930,932 may then allow entry, browsing and selection of a given food item of a database for obtaining a category and description 334,336 to record with the patient's clinical criteria 338. Additionally, the client may additionally add a qualifier. In this embodiment, further referencing FIG. 9B, the client may select one of icon-prompts 340 to rate a preference for a food item, or a relative likeness by the patient. In further embodiments, the template window may also present icons to instruct removal of the identified food item from the food databases to be associated with the patient. For example, the patient may indicate that they do not like lima beans or brussel sprouts and might, therefore, ask that these foods not be presented.

In further embodiments, a dietitian may be allowed to prescribe food items (Rx). In this embodiment, an additional icon might be presented (as will be described in greater detail below) to allow an identified food items to be prescribed. The selection of such prescribe icon may trigger prompts to the dietitian for respective days and/or meals. For example, a dietitian may have a particular reasons for wanting to prescribe fish to a patient on Mondays, Wednesday and Friday.

An additional field or icon may also be presented in the window to allow a user to lock the Food Intolerances. For example, a dietitian may lock the selection of any prescribed or proscribed foods to avoid others from altering these clinical entries.

### Macro and Micro Nutritional Editors

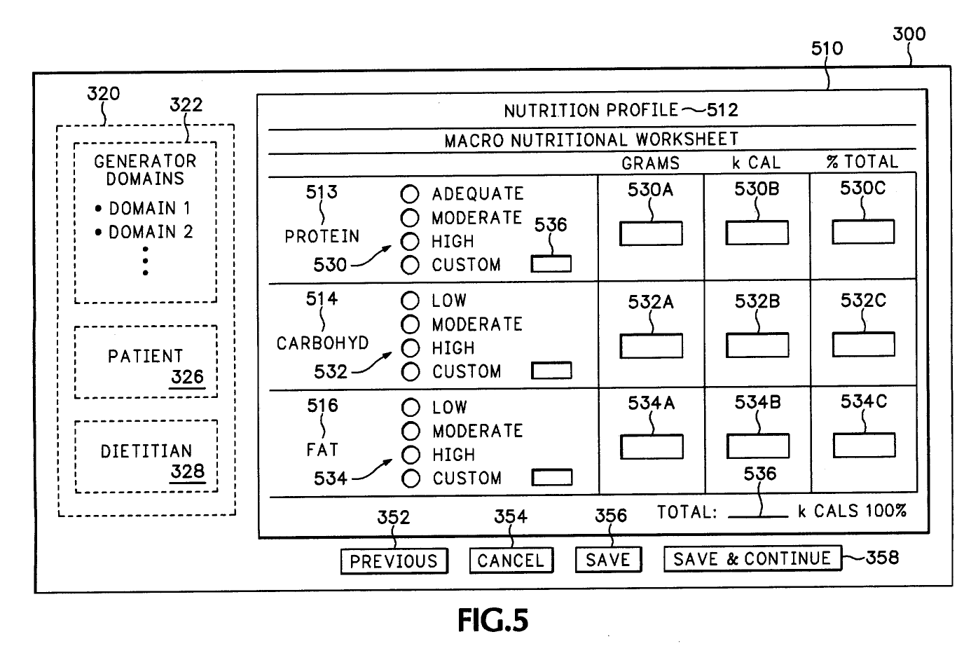

After determining the kilo-calorie budget, the dietitian may proportion the kilo-calories into different meals and into different macro nutritional groups of proteins, carbohydrates and fats. Referencing FIG. 5, a macro nutritional profile template window 510 in accordance with an embodiment of the present invention, may allow for default settings. The default settings may be configured dependent upon the previously determined information of the client profile and activity schedule. The dietitian may then modify these dependent upon their clinical judgment.

In a particular embodiment, the template for the macro nutritional edit window 510 may comprise different rows for the Protein 513, Carbohydrate 514 and Fat 516. Option button/icons 530,532,534 may allow for preset default settings of Low/Moderate/High respectively, or alternatively a selection for custom entry. Upon selection of these entries, a routine of the generator synthesis module may portion the budgeted Kcals into the various macro categories in accordance with the desired percentage breakdowns designated by the dietitian. Know protein/carbohydrate/fat kilo-calorie-to-gram calculations may be used to determine and present the resultant guideline criteria in gram weights in fields 530A,532A,534A respectively. In further embodiments, the Kcal distributions may be presented in fields 530B,532B,534B and the percentage breakouts in fields 530C,532C,534C. These various fields may be used to guide the dietitian for proper selection and distribution of the macro elements.

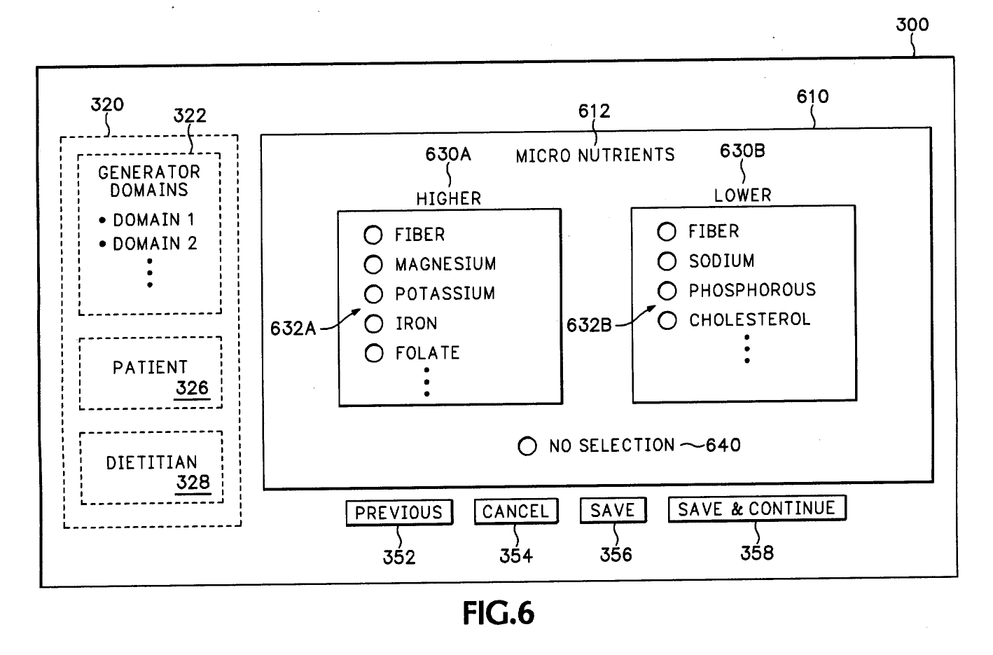

Referencing FIG. 6, micro nutritional template window 610 may, in one embodiment, allow default selections based upon previously determined clinical criteria of the patient. For example, if the patient may be identified with high blood pressure, then a default provision may specify low sodium in column 630. Select/icon 632B may be checked or filled to show its setting for low sodium. Other fields that may be selected by default or left blank for low designations by a dietitian include the exemplary elements of column 630B, which may comprise microelements such as fiber, phosphorous, cholesterol and others.

In a further option, maladies of a patient, or clinical entries of a dietitian, may specify high setting selections to elements of column 630A. The selectable icons may be filled to specify high levels of these elements such as, e.g., fiber, magnesium, potassium, iron, folate,, cholesterol, calcium, etc. In further embodiments, these selections may be screened against default provisions per pre-determined maladies of the patient and may thus generate precautionary warnings to the dietitian.

### Meal Patterns

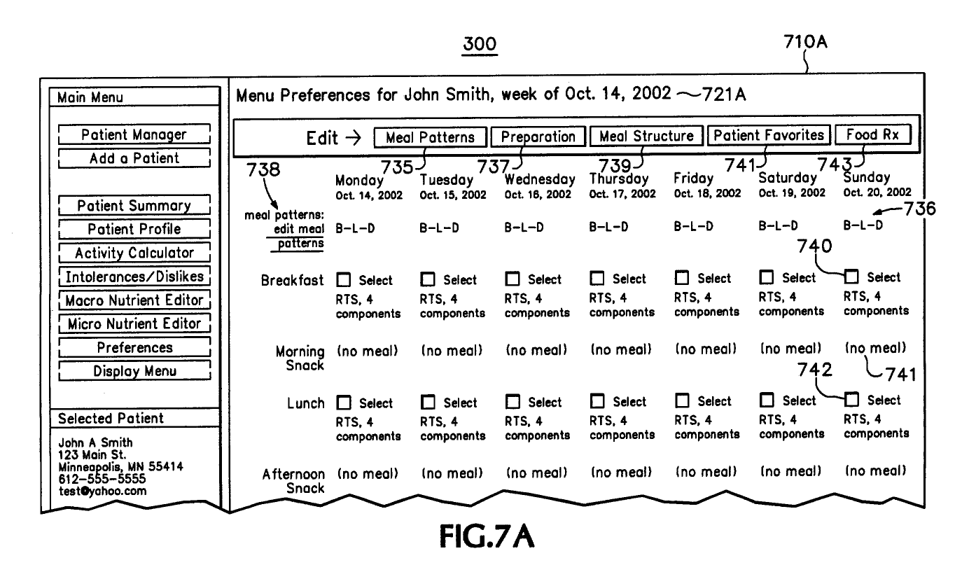

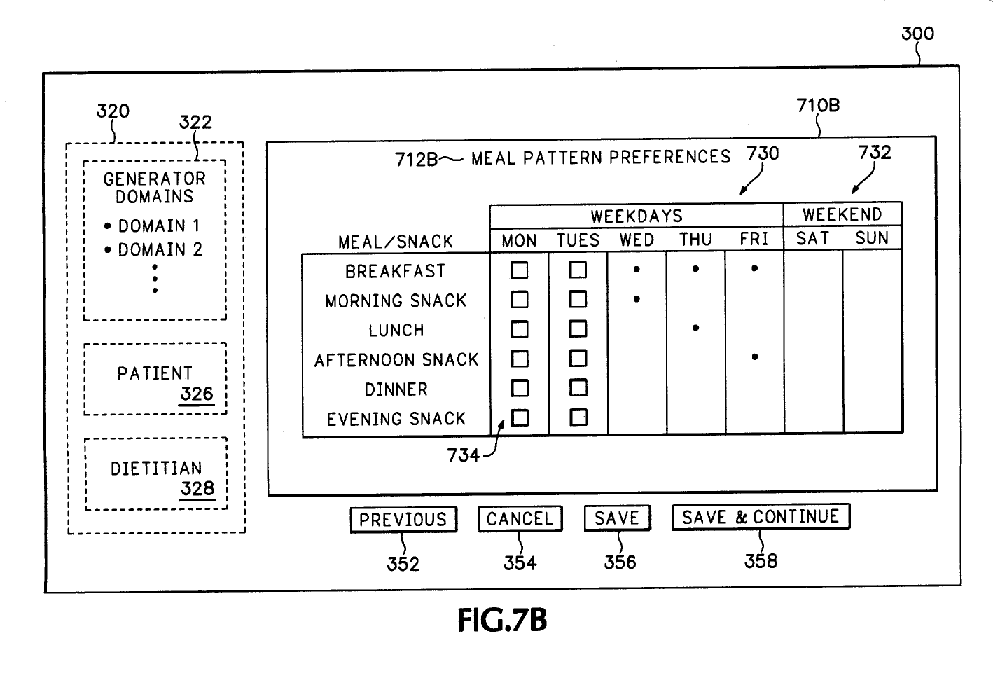

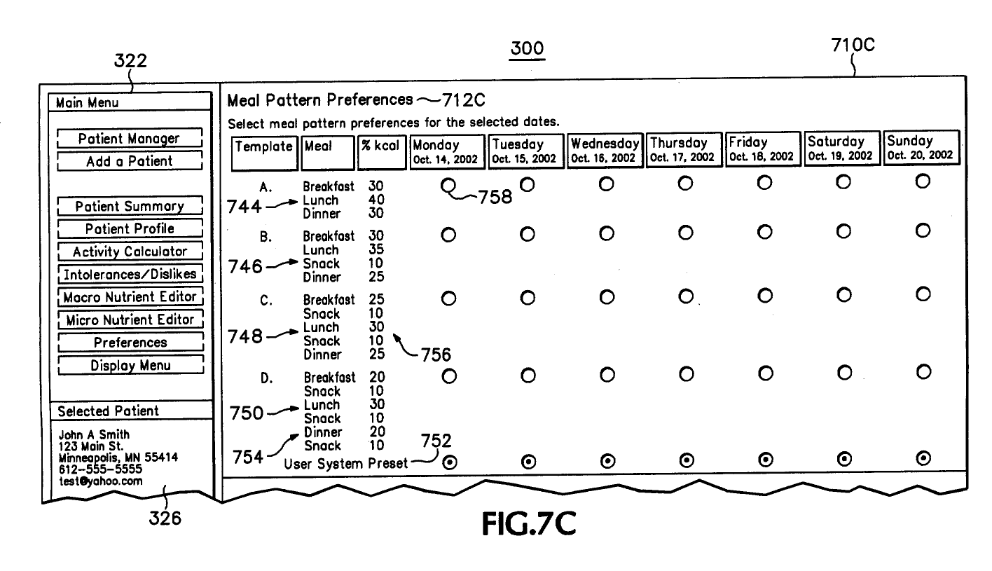

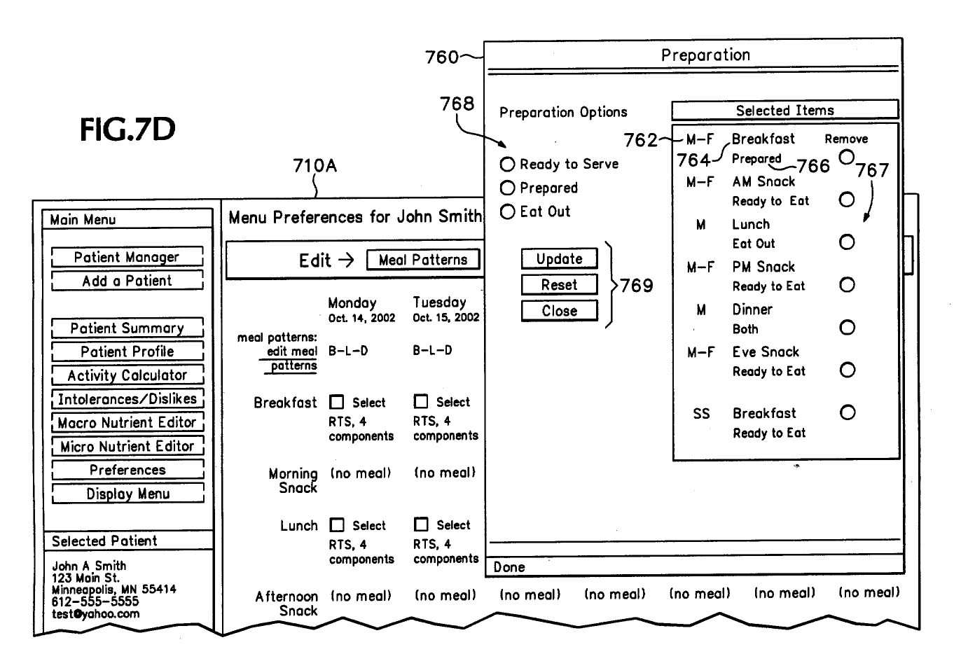

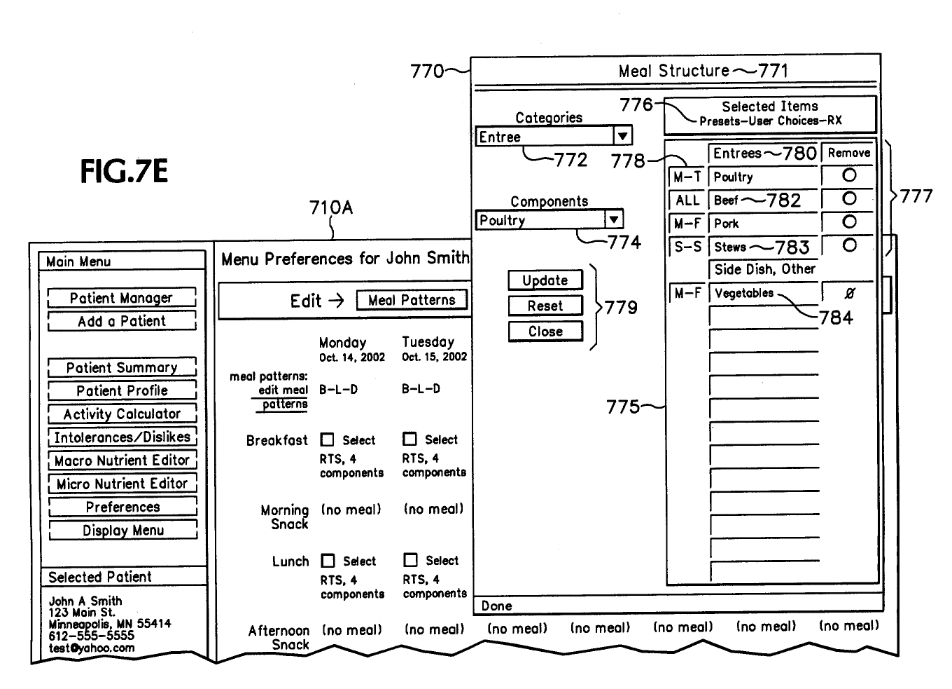

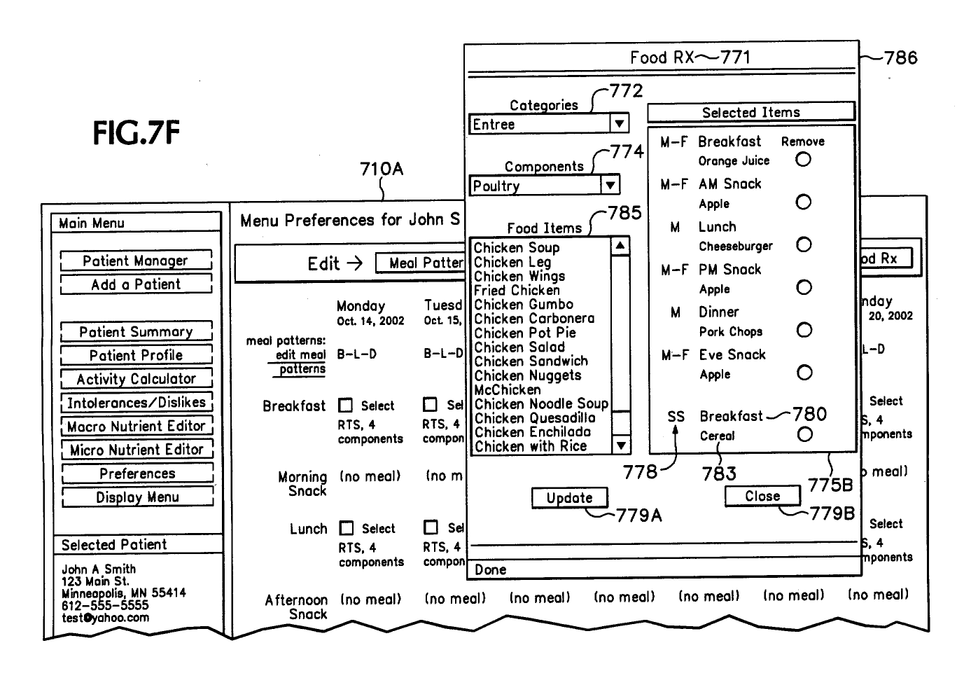

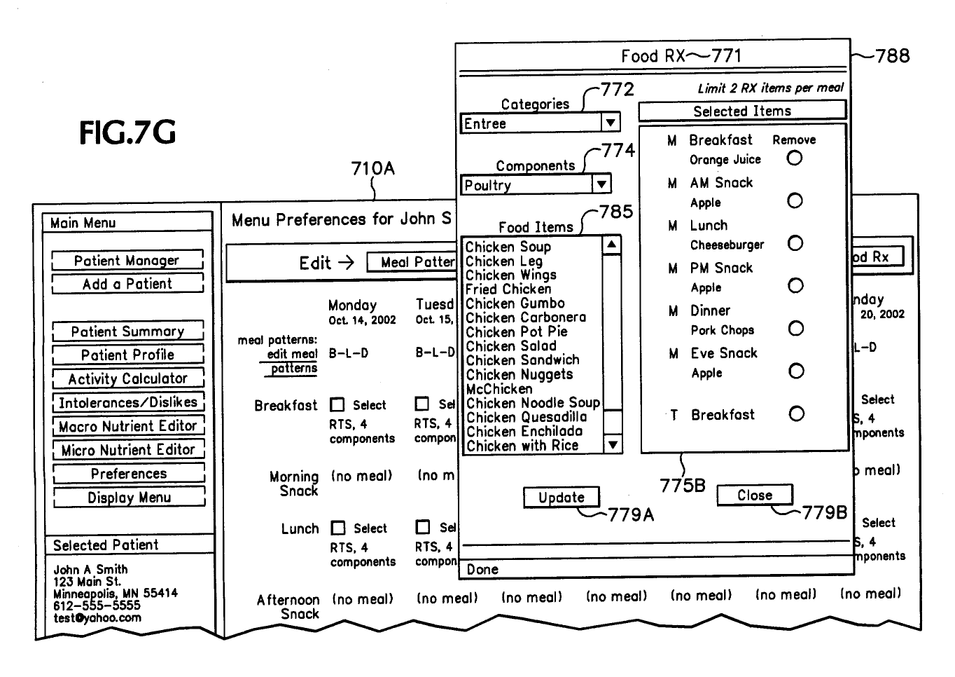

The patient records may also be developed to include meal patterns and meal pattern preferences of the patient. Referencing FIG. 7A, a Menu Preference window 710A may be presented for a given patient over a given week. In a particular embodiment, default meal patterns of breakfast lunch and dinners (B-L-D) 736 may be presented for designated days of the week.

Alternatively, the client may select a hyperlink 738, which may direct process flow to another window such as 710B or 710C of FIGS. 7B,7C respectively to allow custom designations of the meal patterns.

Referencing FIG. 7B the user may be presented selected patterns for daily meals or a blank slate that may then be filled in accordance with a patient's lifestyle. Further, the meals of weekdays may be formulated in unique identifications in contrast to weekends. Alternatively, each day may be presented and formulated independently. In a particular embodiment, days of the week may be presented along columns 730,732 and selectable icons 734 shown in these columns in alignment with possible meals or snacks for the day, such as Breakfast, Morning Snack, Lunch, Afternoon Snack, Dinner and Evening Snack. Additionally, in further embodiments, a dietitian may be presented with an option to “prescribe” meal patterns within part of a clinical plan. Such embodiment may allow the dietitian or patient to set these eating patterns to particular days of the week such as weekends or other days of the week. The dietitian may highlight a particular meal and day, and then select a navigation icon (not shown) to select a particular food item to be prescribed into the select meal.

Additionally, the patient may wish to use such selections to request specific foods that he/she likes. For example, the patient may then enter information to assure menu creation with oatmeal for each morning.

In an alternative embodiment, referencing FIGS. 7A and 7C, a user may select meal pattern icon 735 and be directed to window 710C of FIG. 7C. In this embodiment, a variety of meal templates 744,746,748,750 may be pre-configured and presented by the program for selection by a user. For example, template 744 of template “A” may allocate a meal schedule of Breakfast, Lunch and Dinner and Kcal distribution 756 of the daily budget of 30%, 40% and 30% respectively. Select icons 758 may allow the clinician to select designated meal templates to different days of the week, e.g., Monday-Friday and Saturday and Sunday.

Further referencing FIG. 7C, a lower column 752 may allow the clinician to designate standard system presets for % Kcal distributions 756 which may be pre-configured for the different percentage distribution templates. In other embodiments, the dietitian may de-select a lower icon for a particular day and may then enter a custom Kcal distribution assignment to a given meal of a given template. The dietitian may, for example, choose to assign template “A” 744 with a percentage Kcal distribution of 60%, 15% and 25% for Breakfast, Lunch and dinner respectively.

In another embodiment, referencing FIGS. 7A and 7D, a clinician may select Preparation icon 737 of window 710A and be directed to a preparation option window 760 as shown in FIG. 7C. The window 760 may be presented with Preparation identification 761. A user or clinician may designate a given meal, for example, Breakfast 764 on weekdays 762 M-F to be tailored with food items of preparation category 768 such as prepared 766. The user may highlight a particular day and select an edit icon for that day. The user may further select one of icons 769 to update, reset or close the Preparation selection edit window 760. In this example, the preparation options 768 include “Ready to Serve”, “Prepared” and “Eat Out.” Additionally, the daily assignments may include a particular day (e.g., M), a group of days (e.g., M-F or SS) and all days of the week. In certain embodiments, the client may further designate preparation options of, e.g., various pre-determined recipes. These recipes may be associated with a particular recipe book and integrated into food databases of the menu generation system.

Further referencing FIGS. 7A and 7E, in a further embodiment, selection of Meal Structure icon 739 may direct process flow to Meal Structure window 770. In this embodiment, daily assignments may be designated in column 778, Categories such as Entrees, Side Dish or other in sub-fields (multiple row groupings 777) of the chart 775 and different food identifications 782 assigned to the respective categories and meal groupings. Default items may show-up in one color font, which may be identified by present identification 776A. User choices may be presented in a second color type font and may be identified by user-choice identification 776B. Prescribed foods may be presented in a third color font, which may be identified with RX identification 776C. These color codings may be presented for the respective entries in chart 775 to enable distinction of the entries thereof. Additionally, entries that have been prescribed may be locked, wherein only an authorized dietitian may alter these prescribed foods.

In this embodiment, further referencing FIG. 7E, the Meal Structure window 770 may be presented as a window above underlying gateway window 710A. After completing revision, reset or view of Meal Structure window 770, the window and associated settings may be updated and closed per selections 779.

Further referencing FIGS. 7A and 7F-FG, in accordance with further embodiments, the user (patient or dietitian) may select Patient Favorite icon 741 and/or Food RX icon 743 respectively to enter different edit windows 786 and 788, of identifications 771 Patient Favorites and Food RX respectively. Each of these windows may present similar fields, a select category may be designated in sub-window 772 and food component 774 in sub-window 774. These may be used by a patient/dietitian to designate foods into respective charts 775B. Particular days may be designated in column 778 and meals 780 and entries 786 within the respective favorite/prescription charts 775. Additionally, more particularized food items may be further represented for selection in sub-window 785.

### Categories and Components

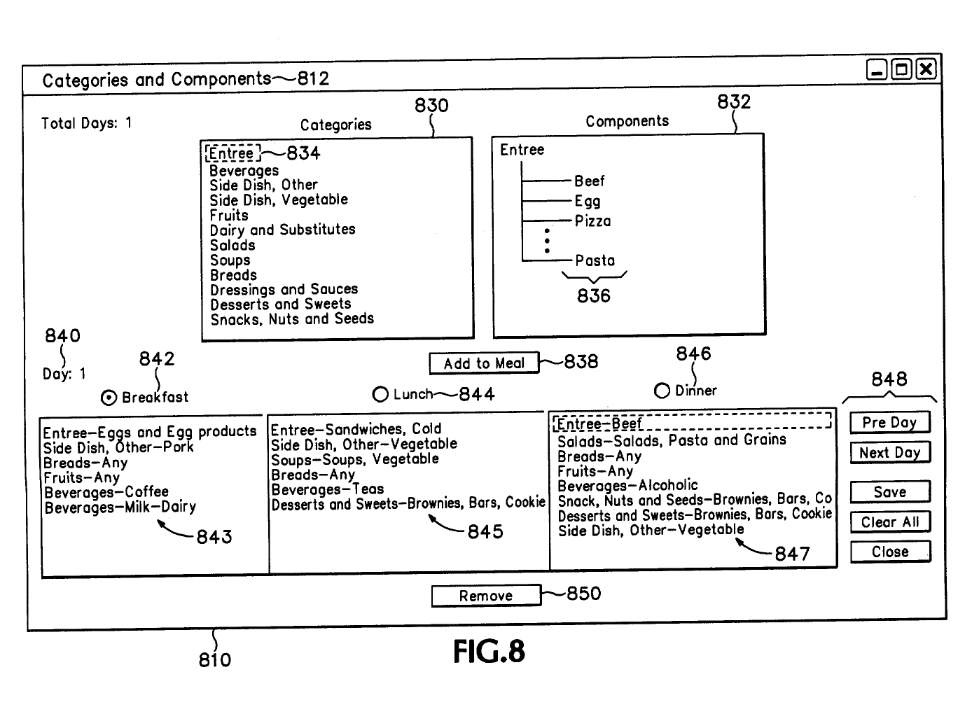

In further embodiments, referencing FIG. 8, the client (patient/dietitian/etc) may be shown an alternative category/component window 810 to query choices from amongst various options for categories 830 and components 832 that may be used in structuring different meals in a clinical menu cycle. It may be noted that this window may serve as an alternative to the Meal Structure edit window 770 of FIG. 7E, which may be used to edit food category and components of databases to be used in menu synthesis procedures.

In this embodiment of FIG. 8, different meal selection indicators, e.g., Breakfast 842, Lunch 844, Dinner 846 may allow selective editing to particular meals of a particular day as shown in day indicator 840. Categories may be presented in field 830 such as Entree, Beverages, Side Dish, Vegatable, Fruit, etc. Upon highlighting 834 a particular category as selected by a user, field 832 may be constructed to list components 836 (e.g., Beef, Egg, Pizza . . . Pasta) available to the select category 834. Select icon 838 may allow user selection for adding the designated component and category to the particular meal designated in the menu cycle. This may be continued for other categories, meals and days in the menu cycle. Likewise, a particular entry may be removed from a given meal. For example, the entry may be highlighted and the select removal icon 850 selected. Navigation/Edit icons 848, such as Previous Day, Next Day, Save, Clear All, and Close, may allow further handling of information presented for the various Category and Component provisions of edit window 8 10.

### Synthesis

After establishing some of the setup provisions, menu synthesis may proceed. According to an embodiment of the present invention, clinical menus may be generated using clinical criteria of the patient to tailor a clinical menu to needs of the patient. The tailoring may be based on the attributes determined for the patient.

Foods items may be included in the meals when they may meet budgeted kilo-calories and nutritional guidelines. The menu generation, in structuring a particular meal, may target food items suited for meeting the particular macro-nutritional and/or the micro-nutritional guidelines for the clinical criteria of a patient. These attributes, in such embodiment, may be used to direct and influence selection of foods and the menu generation.

In exemplary embodiments, attributes of the clinical criteria may be used to establish indexes to index select regions or subgroups of available food databases. Keying into the database with preestablished micro or macro nutritional index designations may, thus, reduce the realm of food items available for selection during generation of the clinical menu.

For example, the micro-nutritional guidelines in the clinical record of a patient profile may specify high calcium and low fiber (e.g., as may be specified in a template window 610 of FIG. 6). These guidelines may then be used to prevent access to particular regions of a food database (library 50 of FIG. 12 or Food Database entity 80 of FIG. 2) that may be associated with food items of low calcium or high fiber.

In accordance with certain optional embodiments of the present invention, the database may comprise records to food items also comprising address mappings to enable indexing on the basis of their nutritional categories (i.e., categorized by low or high calcium, low or high fiber, etc.). With this type of indexing in the food database, the records of the database may be indexed more readily based on criteria of the patent to allow ready selection from only those food items that may have been previously characterized with, e.g., low/high fiber.

In a further embodiment, they may be categorized with additional relative levels—such as, low/moderate/high levels of the respective elements—as opposed to just the simple high or low categorizations.

In the particular embodiment described above, the database may include indexes to enable indexing of records on the basis of their relative levels of micro-nutritional elements of calcium or fiber. It may be understood that other embodiments of the present invention may comprise mappings or indexes based on the other micro-nutritional elements, e.g., amino acids, fatty acids, bioactive compounds, and other vitamins and minerals. Additionally, the database may comprise indexes for the records to enable indexing on the basis of other attributes as may be associated with a menu structure or patient profile. Such mappings and indexes, referencing FIG. 2, may allow the use and formation of relational structures 68,78,85 between the various entities of Patient 60, Patient Menu 70, and Meal Menu 90.

These relationships between the entities of the food databases may employ indexes based on relative levels of micro-nutritional elements such as low sodium, high potassium, etc.; on the basis of relative macro-nutritional elements such as high protein, low carbohydrates, moderate fat; in additional to the particular meal that the item would typically be associated such as breakfast, lunch, dinner or snack. Furthermore, the indexes may also be based on a category of a meal such as an entree, side dish, condiment, beverage or dessert; and perhaps also by respective components to the meal categories, for example, a pork meat component (e.g., as a side dish of a breakfast type meal), a dairy component for a side dish, egg component to an entree, coffee component to a beverage, etc. Again, these pre-configured index structures for such embodiment, may assist ready selection of food items of relevance for meeting desired objectives and guidelines for menu generation.

In further embodiments of the present invention, the databases may also be keyed to enable indexing by types of malady of a patient, such as the maladies of high blood pressure, renal disease, diabetes, etc. Such indexing may allow rapid screening of food items from the database based on attributes of a client profile alone. For such embodiments, food selections may be initially influenced by indexes taken from particular attributes of a clinical record or meal structure, which in turn may close-off certain regions of an overall food database. Particular structuring of architectures, assemblies and techniques of “relational databases” may facilitate the initial coordination of domains in the databases. In exemplary embodiments, the database architecture may be represented as entities with attributes to establish relationships to records of other entities such as those illustrated in the exemplary E-R model 50 of FIG. 2. These entities may have a variety of keys that tie into records of other entities of many-to-one, one-to-one or one-to-many inter-record relationship(s).

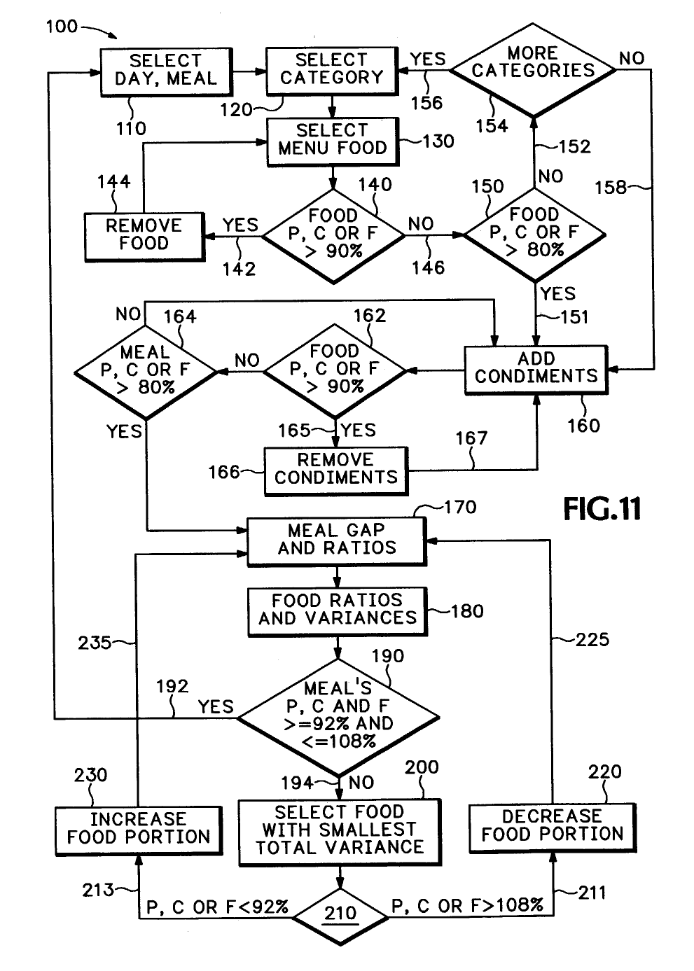

Referencing FIG. 11, an embodiment for a method of clinical menu generation may comprise selecting a day, e.g., Monday, Tuesday . . . and a meal for the day such as a breakfast, lunch, dinner or snack to be filled. A category may also be identified for the meal, such as an entree, side dish, beverage or desert. After identifying a category, a component to the category may be selected at random from a pre-established list therefor. Examples of components to categories include, for example, an egg for an entree, a carbonated drink for a beverage or yogurt to a side dish. Pre-established lists may be available for establishing the various categories and components. They may further be associated for relationship to publicly available databases or specially databases of given vendors or food-manufactures.

The USDA provides one source of food items of a public database. A query to the food database may produce information of a particular food item such as, for example, a chicken breast with or without bones. The weight may be entered as three-ounces to establish a quantity to the food item. Conventional tools may provide further analysis of the food item to establish its nutritional breakdown. This type of analysis may be performed for a plurality of food items in a given meal.

In one embodiment, a menu may be divided into days and meals. The meals may be further divided into categories and components. This information may then be used, in one embodiment, to designate sub-groups or regions of the overall food database from which records may be pulled to fill the specified menu fields. Other attributes of the clinical record may also be used to designate, or alternatively block out, regions of the food database during selection of food items when generating clinical menus for patients. In other words, the categories and components pre-established for a meal and in addition to attributes of a patient's clinical record, may each individually, or alternatively and collectively, influence the availability of food items that may be available for selection from the food database. Other provisions of the clinical records, either alone or in combination with previous attributes, may then influence how to pick or chose food items from the previously defined pool or sub-region(s) during the generation of the clinical menu.

With reference to FIG. 11, a menu generator and method of menu generation may automatically create clinical menus based on pre-established clinical criteria of a patient. A user, such as a dietitian, may previously establish a number of daily kilo-calories targeted for a patient and a number of grams of protein, fat and carbohydrate required for the patient within the kilo-calorie budget. The dietitian may further structure the number of days for the menu. The client may also indicate categories for the meal and meal patterns within the menu cycle. The criteria may further include food preferences, prescriptions and/or likes/dislikes or intolerances of the patient.

The menu generator, with these setup provisions, may construct a menu for the patient, one meal at a time day-by-day within the menu cycle. In generating the meals of the menu, the generator may select food items matching the selected categories and components while also balancing a distribution of grams of protein, fat and carbohydrate that may have been previously tailored by a dietitian into guidelines for meeting clinical needs of the patient.

In accordance with an example of an embodiment for a method of menu generation 100, referencing FIG. 11, a day and meal of the menu may be determined 1 10 for selection of food items. Next, categories may be identified 120 for the meal such as categories of an entree, beverage, side dish, dessert etc. Additionally, components may be specified for the categories such as an egg component to an entree category from which a food item may then be selected 130 such as scrambled eggs.

After selecting a food item, a query 140 may determine if the food item initially selected may comprise more than 90% of the protein, carbohydrate or fat values designated from the clinical criteria. If the food item would provide more than 90% of one of these macro-nutritional element guidelines, then the method moves along path 142 and removes 144 the initially selected food item (e.g., scrambled eggs) and may select 130 an alternative food, e.g., poached eggs.

If query 140 may determine a selected food item to meet the macro-nutritional guidelines, then the process may proceed along path 146 to another query 150 to determine if the meal thus constructed meets at least 80% of the protein, carbohydrate and fat objectives. If the query determines that the meal contains less than 80% of these nutritional goals for the meal, then the generator may move forward along path 152,154,156 to obtain more calories to meet the kilo-calorie budget for the meal. The generation may then proceed to fill another category for the meal, e.g., to select a beverage for the meal. If the meal should substantially meet the calorie budget established therefore, then the method may follow an alternative path 152,154,158 to consider addition 160 of a condiment. Likewise, should the previous query 150 determined that the food items of the meal thus constructed comprise nutritional elements exceeding 80% of the macro-nutritional guidelines, then the generation may similarly move 151 to consider addition 160 of condiments.

The generation of the clinical menu may perform the procedures 160,162,163,164 of “add condiments” 160, query “food PCF >90%” 162, and query “meal PCF >80%” 164 to add condiments to food item(s) of the meal until meal nutrients may meet at least 80% of the targeted nutritional guidelines. This routine may also aim to keep the food with condiment within the desired 90% values of the protein, carbohydrate and fat guidelines established therefor. If the food item with condiment additions should exceed a 90% threshold for proteins, carbohydrates or fats, then the generation may opt 165,166,167 to select a replacement condiment 160 or to choose an alternative food for receiving added condiments.

In accordance with one embodiment, the food items that may be used for creating a menu may be obtained from available databases such as the USDA Nutrient Database for Standard Reference, Release 14(SR14). The database may provide records to about 6000 food items. About 1500-2000 of these foods have been further selected as appropriate “menu foods.” These menu foods may be further characterized with portions of minimum, typical and maximum. The amount or portion of these menu foods may be increased or decreased by a given incremental amount until reaching the minimum or maximum levels. The nutrient content of food items may, thus, be derived from such exemplary food database.

It may be understood that alternative embodiments of the present invention may use food databases other than the USDA Nutrient Database, or may add additional food records or employ a combination of different databases, which may become available.

Additionally, in accordance with an embodiment of the present invention, each menu food of the food database may have one or more meal categories (i.e., entree, side dish, beverage, dessert, etc.) to which it may be associated or indexed. These categorizations, again as described previously herein, may assist in an allocation of regions or sub-regions of the database to be indexed and drawn upon for the selection of certain food provisions.

In a further embodiment, once a particular food type or component has been selected (i.e., egg, pork, etc.), it may then be blocked from selection to other categories of the meal and or menu. This may assist generation of a menu with varied food types in the make-up of a meal.

Furthermore, the categories may be prioritized to ensure that a meal fills more important elements first before filling others. These priorities may also be used to assist determination of particular food items that may be adjusted in portion size (discussed more fully herein below) or when designating a particular food item to remove from a meal.

Another embodiment may allow provision of categories and meals of prescribed (or Rx) food items. For example, a dietitian may prescribe a patient fish for dinners on Monday, Wednesday and Friday. These prescribed foods may then be assigned into the prescribed categories and meals first before synthesis of the rest of the menu and may thus be viewed of utmost priority. The menu generation will take into consideration these prescribed food items when determining the nutritional guidelines for affecting the synthesis of the other meals and categories of the menu.

After filling the various categories of a meal with selected food items, menu synthesis may proceed to a refinement process. The refinement process may be described as performing analysis and adjustment of Meal Gaps and Ratios.

Further referencing FIG. 11, meal gaps and ratios may be determined 170 after the various components for a meal have been populated with food items and their nutritional break down determined to meet at least 80% of the macro-nutritional clinical criteria. The “gap” may be defined as an absolute value of a nutrient target for a meal minus the actual value for the same nutrient element in the meal. For example, a protein gap may comprise the absolute value for proteins targeted for a meal minus the total proteins determined from an analysis of the meal just generated.

The “ratio” may be referenced alternatively as the “gap ratio.” In this embodiment, it may be defined as the gap for a given nutrient divided by the sum of all nutrient gaps. Additionally, this value may be multiplied by 100 and the ratio term may be described as a percentage. For example, a protein gap ratio may equal to

GAP RATIOₚᵣₒₜₑᵢₙ=GAPₚᵣₒₜₑᵢₙ/(GAPₚᵣₒₜₑᵢₙ+GAP_{carbs}+GAP_{fat})×100

Gaps and Ratios may be determined for each macronutrient of the meal. In a further embodiment, these Gaps and Ratios may be stored in a pre-established table for the menu generation user or operator (such as the patient or dietitian). The Gaps and Ratios would be stored in the table associated with the respective meal and day.

After determining gaps and ratios 170, ratios and variances for the foods may be determined 180. These may be determined by firstly, obtaining the macronutrient breakdown of each food. For each nutrient element, the food ratio may be calculated taking the given nutrient determined for the food divided by the sum of all its nutrients. For expression as a percentage, this result may be further multiplied by 100. For example, a food protein ratio may be calculated by the follow:

Food Protein Ratio=[Food Protein/(food protein+food carbs+food fat)]×100

The variance for each nutrient for each food may then be determined by taking the absolute value of the food's Ratio minus the meal's Gap Ratio. Further to the above examples, the food protein variance may be represented by the expression

Food Protein Variance=ABS (food protein ratio−meal protein gap ratio)

These variances of the nutrients may be summed together to provide a total variance for the food. In particular embodiments, the food ratios, variances and total variances may be stored in the table pre-established for the user and associated with the respective meals and day. These values may be recalled subsequently to assist analysis and possible adjustments to menu meals.

After determining the variances, further referencing FIG. 11, the current percentages of each macronutrient in the meal may be examined 190. If all nutrients of the meal are within predetermined guidelines for the meal, then the meal may be described as meeting its target for each nutrient and another meal may be generated by way of path 192. It may be understood that if all meals of a day have been generated, the process will begin generating meals for a new day of the menu cycle. Likewise, it may be understood that if all meals for all days of the menu have been generated, then the menu generation may be complete. The resulting menu might then be presented to the user.

In a particular embodiment, the nutritional guidelines may be set to a certain tolerance about a nutrient goal. For example, the tolerance in one embodiment may be set to about ±8%. For such embodiment, proteins for a meal may be examined to determine if their levels are between 92 and 108% of the protein goal of the meal. Likewise its carbohydrates and fats may be examined to determine if their levels fall within 92 and 108% of their respective targets. The meal may be described as meeting its macro-nutritional guidelines if the nutrients for the meal fall within ±8% of their respective goals. In alternative embodiments, these tolerances may be set to values other than ±8%. Additionally, the tolerances may comprise different levels for the various nutrients.

If a particular meal has not met its macro-nutritional guidelines 194, the menu generation may advance to a step of identifying 200 a food item in the meal that may be best suited for adjustment in order to bring nutrients of the meal within predetermined nutrient goals, e.g., ±8%. These food item(s) may then be adjusted in proportion, either increasing or decreasing their portions in the meal, so as to adjust the nutrient contents of the meal into conformity with its nutrient guidelines.

In one embodiment, a routine may be performed to analyze the previously determined food Ratios to select a food item of nutritional make-up appropriate for making an impact upon the meal total if its portion is adjusted. For example, if the protein level of a meal may need adjusting, it may be more appropriate to adjust a portion of an egg item within the breakfast as opposed to making an adjustment to the portion of an orange juice beverage. In this example, an adjustment to the egg portion may provide a more effective impact on meal protein levels in comparison to adjustment of orange juice portions. Accordingly, the program may examine the food ratios to identify more than one food items that may be adjusted for affecting the nutrient levels. In a particular embodiment, three different food items may be identified for possible adjustment.

Next, continuing with a further embodiment, to determine which of the food items to select for adjustment of a given nutrient, the menu generation routine may examine the previously determined food variances (e.g., these values may be retrieved from the table pre-established for the user and associated with the food items and meal) and identify the food item of smallest variance for the particular nutrient. If the percentage of the nutrient in the meal is determined 210 to be greater than 108% of its target value 211, then the food item identified of the smallest variance for this particular nutrient may have its portion reduced 220. Alternatively, if the level of this given nutrient in the meal is determined 210 to be less than 92% of its target value 213, then the food item identified may have its portion increased 230. After adjustment of portion of a food item in the meal, the meal analysis may return 225 or 235 to calculation of Meal Gaps and Ratios 170.

These procedures of determining Meal Gaps and Ratios 170, food rations and variances 180, meal analysis for guideline compliance 190 and possible adjustments 200, 210, 220, 230 may be repeated until obtaining a meal that may conform to the nutrient guideline. However, if a minimum or maximum portion of the food item has been reached or the food's portion cannot be adjusted without going below or above the nutrient's tolerance level, then a substitute food item may be selected for adjustment.

If, however, there is a need to select a food item of the meal, the program may determine if one of the foods exceeds the 108% nutritional guideline and may then substitute the food item with one that may provide a better fit to the meal's overall goals. The meal may again be analyzed by these procedures 170-235 of determining meal gaps and rations, food ratios and variances, and analysis of meal nutritional conformity and possible portion adjustment.

In a further embodiment, an additional analysis and adjustment may be performed. The nutrient levels of the meal may again be examined and a percentage determined by which each nutrient might deviate from its target for the meal. If the percentage determined for a discrepancy of each nutrient is less than or equal to 8%. Then the meal may be deemed complete and an additional meal process may be pursued 192,110.

If a greater discrepancy, e.g., greater than 8%, is determined, then the program for menu generation may identify the nutrient of largest discrepancy and calculate a range in grams, for example, of the nutrient that may need to be added for bring the meal percentage within its 8% tolerance level. The most that the gram weights may adjusted may be defined by

Adj_{min/max}=(nutrient target±0.08(nutrient target)−nutrient total

If a food item in the menu may be found to enable adjustment within the min/max Adjustment range, which may provide an adjustment of the nutrient value within the desired guidelines; then the program may adjust the portion of the food identified for bring the meal within its nutrient guidelines. After such adjustment, the meal analysis 170-190 may be repeated to verify compliance of the meal with the nutritional guidelines.

In a further embodiment, if a food item may not be found in the meal suitable for adjustment with the min/max adjustment range, then the portions of all foods in the meal may be restored to their initial levels. The menu generations may pursue the procedures 170-235 (i.e., calculation of the meal gaps and ratios, food ratios and variances, meal analysis and possible food adjustment) again but with preference to alternative foods for adjustment or replacement of select food items therefore with replacement that may be more in-line with the meal objectives.

Again, once a meal may be determined to be within its nutritional guidelines, the program may proceed to generate another meal of the menu. In accordance with one embodiment of the present invention, a method of menu generation may incorporate residual nutritional deviations of meals previously generated into the synthesis of follow-on meals. Such embodiment may adjust the nutritional targets for the subsequent meals in accordance with the previous residuals. By affecting the target values of the later meals dependent on the residuals resulting from the previously generated meals, an overall accumulated deviation per day (or menu cycle) may be kept to a minimum.

For example, a breakfast may first be generated with a protein level at 102% of its target value. When generating a lunch for the same day, the initial target value for proteins for the lunch may be reduced by 2%. Likewise, if the breakfast meal resulted with a −5% residual for carbohydrates, the program may adjust the carbohydrate target for the lunch by +5%. Accordingly, upon reaching the end of the day the combined nutritional breakdown of all meals for the day may be kept within ±8% of any one meal.

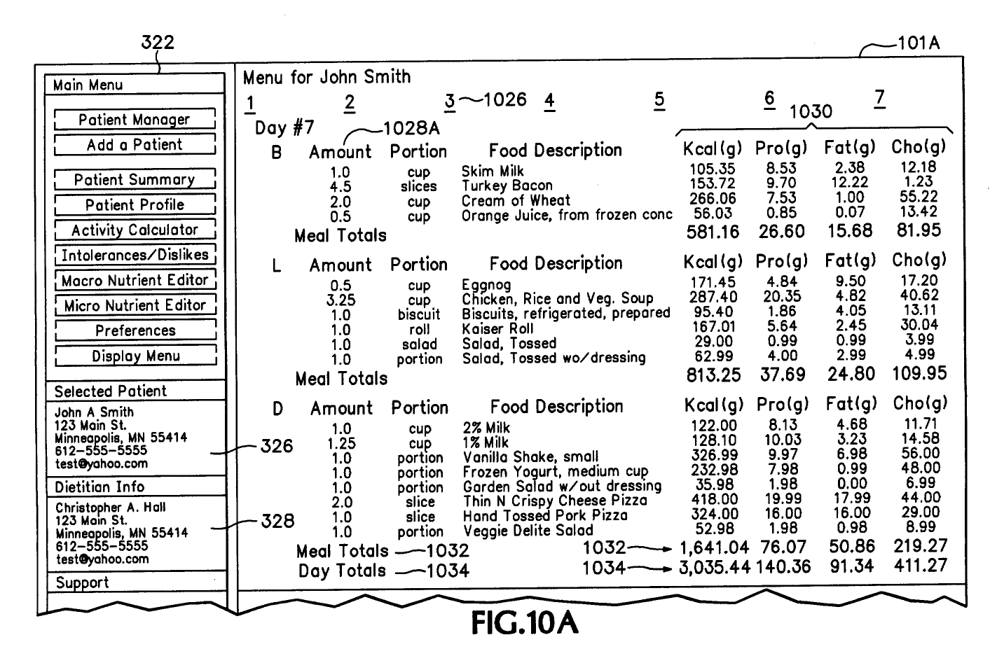

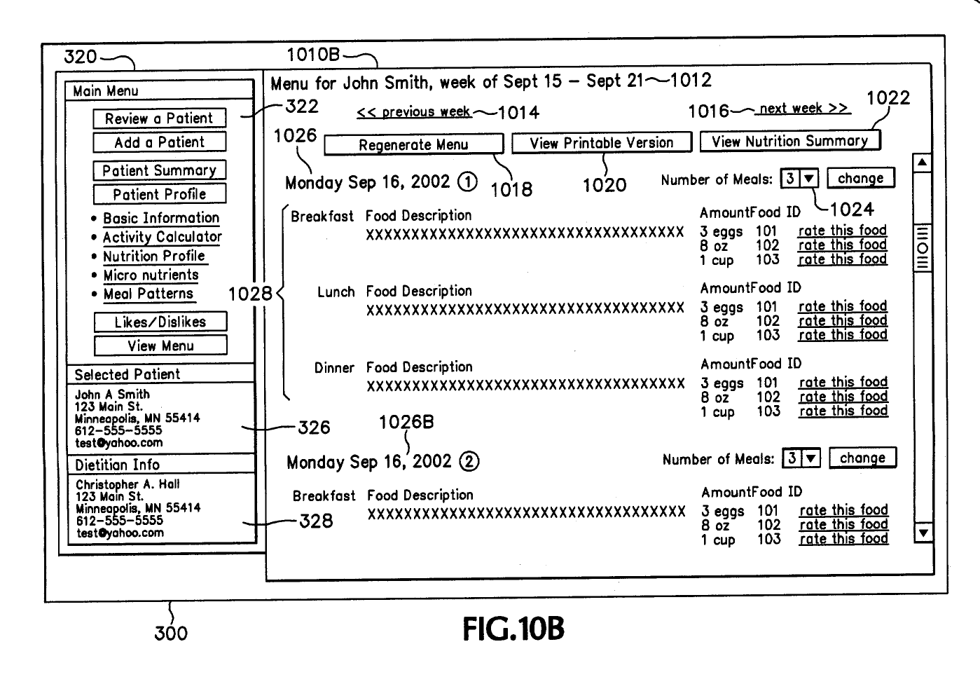

After generating the clinical menu, the clinical menu may be presented to the user. Referencing FIG. 10A, a particular day 1026 of the clinical menu may be presented in a screen such as that of window 1010A of FIG. 10A. The display may present information of patient and a day of a menu cycle. The different meals may then be presented in different meal categories such as breakfast, lunch and dinner (e.g., B, L and D). A meal may be further itemized with information of Food Description, Amount and Portion in respective Meal records 1038A. Additionally, the nutritional breakdown of the items in the meals may be presented in columns 1030. In this embodiment, the columns 1030 provide information of Total Kcals, Protein grams, Fat grams and Cholesterol grams. Additional fields 1032, 1034 may present information of nutritional breakdowns for the meal totals and totals of all days of the menu cycle.

In a further embodiment, referencing FIG. 10B, an exchange list may also be generated and presented. A window 1010B may present title 1012 indicating a menu of a given patient across a designated menu cycle. The window for this embodiment may include selectable icons 1014,1016 to transition the display to reveal a previous or subsequent week's menu. Further options may include a field 1024 for selecting the number of meal options for the exchange list and another field to allow a change in a menu of the exchange. The particular meals 1028 may be presented, for example, as Breakfast with associated food descriptions, amounts and identifications. A further hyperlink may allow the user to enter a rating for the food item should they wish to record a preference to assist subsequent synthesis procedures.

Additional navigation selection icons 1018, 1020, 1022 may allow the user to request generation of a new menu, printing of an existing exchange or view of a menu's nutritional summary.

While certain exemplary features of the embodiments of the invention have been illustrated and described herein, may modifications, substitutions, changes and equivalents may now occur to those skilled in the art. It is, therefore, to be understood that the appended claims are intended to cover all such embodiments and changes as fall within the spirit of the invention.

What is claimed is:

1. A method of generating a clinical menu, comprising:
selecting a food item from a database; and
influencing the selection of the food item based on a clinical record of an individual.

2. The method of claim 1, further comprising:
identifying an attribute from the clinical record; and
indexing the database with the attribute;
the selecting to select a record from amongst those of the database of key indexes matching the attribute index.

3. The method of claim 2, in which the indexing is based on an attribute of the group consisting of at least one of a relative level of a micronutrient, a relative level of a macronutrient, a heath condition of the patient, and an eating preference of the patient.

4. The method of claim 1, the selecting and affecting to comprise:
determining nutritional elements associated with a food item in the database;
determining nutritional guidelines for the individual based upon their clinical record; and
comparing the nutritional elements determined for the food item to the nutritional guidelines determined for the individual;
the selecting of the food item based on the comparing.

5. The method of claim 4, the comparing to determine a correlation of the nutritional elements of the food item relative to the nutritional guidelines for the individual; and
the selecting of the food item based upon the correlation determined.

6. The method of claim 5, in which the comparing determines a correlation of at least one micronutrient of the food item relative to the nutritional guideline thereof for the individual.

7. The method of claim 1, the selecting and affecting to comprise:
identifying a nutritional ratio guideline from the clinical record of the individual;
determining a correlation of a nutritional breakdown of the food item of the data bank relative to the nutritional ratio guideline; and
allowing selection of the food item dependent on the correlation determined.

8. The method of claim 1, in which the influencing comprises:
determining food allergies, intolerances or dislikes of the individual; and
preventing selection of certain food items within the database based upon the food dislikes or allergies determined.

9. The method of claim 8, in which the affecting further comprises:
determining food preferences of the individual; and
favoring the preferred food items in the database during the selecting.

10. The method of claim 1, further comprising:
retrieving the clinical record of the individual from a database; and
the selecting and influencing to comprise:
identifying at least one nutritional element of the macro and micro elements for a food item of a food database,
determining guideline(s) for such nutritional element(s) dependent on the clinical record retrieved; and
comparing the nutritional element(s) identified to the guideline(s) determined therefor.

11. The method of claim 10, in which the identifying and the determining are based on a pre-identified malady of the individual.

12. The method of claim 10, in which the selecting and influencing comprises repeating the identifying, the determining and the comparing for each nutritional element of the macro and micro elements.

13. The method of claim 12, further comprising incorporating the food item selected into a meal plan for the individual if the nutritional elements of the food item are determined to be within their guidelines as determined therefor from the clinical record of the individual.

14. The method of claim 13, in which
the obtaining information of the food items comprises accessing a food database across a network; and
the obtaining the clinical record for the individual comprises accessing a clinical database over the network.

15. The method of claim 10, further comprising:
identifying a day and meal for the menu;
identifying a category and component for the meal; and
obtaining a budget of kilo-calories and grams of protein, fat and carbohydrate as guidelines for the individual;
the selecting to comprise:
accessing records of the database with foods matching the category and component identified;
retrieving food items from the records accessed to meet the kilo-calorie, protein, fat and carbohydrate budget; and
adding one of the food items retrieved as a part of creating the meal for the category and component identified.

16. The method of claim 15, further comprising repeating the selecting for each category identified for the meal.

17. The method of claim 16, after performing the initial selections for each category of a meal,
totaling the kilo-calories, proteins, fats and carbohydrates for the food items of the meal just created; and
checking ratios and variances of the proteins, fats and carbohydrates for the food items of the meal from the totaling relative to their pre-determined budgets.

18. The method of claim 17, if the totals of the food items of the meal are outside the budget, then identifying a correction goal;
determining a select food item of the meal of smallest variance relative to the targeted budget and correction goal; and
modifying a portion of the select food item to adjust the totals for the meal.

19. The method of claim 17, if the totals of the food items of the meal are within the budget, then selecting a new meal and again performing
the identifying of categories and components,
the obtaining a budget for the meal, and
the selecting of the food item.

20. The method of claim 19, the obtaining the budget for the meal to take into account the totals determined for meals previously created.

21. The method of claim 20, the obtaining the budget further to incorporate prescribed foods of the individual.

22. The method of claim 15, further comprising:
prioritizing the categories;
the selecting for each category to handle categories of higher priority before others.

23. A system comprising:
a host having access to a food database and client database;
a client station operable to communicate with the host;
machine readable storage media to store a sequence of instructions in communication with the host, which when executed thereby, cause it to
display and operate an interactive window in the client station to establish information for an individual;
retrieve clinical criteria from a patient database dependent on the information established;
influence food items of a food database with selection preferences dependent on the clinical criteria retrieved for the individual; and
select food items of the food database to generate a meal dependent on the selection preferences.

24. The system of claim 23, in which the instructions further cause at least one of the host and client station to display the meal generated in a menu window.

25. The system of claim 23, in which the instructions further cause at least one of the host and client station to
identify a clinician from the information gathered;
identify a patient from the information gathered;
determine a clinician-patient relationship between the clinician identified and the patient identified; and
retrieve the clinical criteria for the patient dependent upon the relationship determined.

26. The system of claim 23, in which the instructions, when executed by at least one of the host and client station, further cause them to
make the influence of food items and the selection of food items for the menu creation contingent upon the presence of a clinician-patient relationship determination.

27. The system of claim 26, in which the instructions, when executed by at least one of the host and client station, further cause them to block menu creation and enable food and menu analysis when determining an absence of a clinician-patient relationship.

28. The system of claim 23, in which the instructions, when executed by at least one of the host and client station, further cause them to
gather clinical attributes of the patient, the attributes consisting of at least one of the group of age, weight, height, gender, activities, maladies, meal patterns, meal preferences, categories and components, prescription foods, likes, dislikes and intolerances.

29. The system of claim 28, in which the client station comprises:
a dietitian station to display and operate a dietitian window,
the instructions, when executed by at least one of the host and dietitian station, to cause the dietitian window to prompt and assist a dietitian in a formulation of the clinical criteria of the patient;
at least one of the dietitian station and the host to comprise a patient database to store the clinical criteria formulated;
the instructions, when executed by at least one of the host and dietitian station, further to cause a record for the patient and the clinical criteria to be stored in the patient database.

30. The system of claim 23, in which the client station may comprise at least one of a dietitian station and a patient station, the instructions, when executed by at least one of the host, the dietitian station and the patient station, operable to present the interactive window in at least one of the dietitian and patient stations.

31. The system of claim 23, further comprising a network to carry signals between the host and client station.

32. The system of claim 31, in which the host comprises a web-site addressable across a network; and
the client station comprises a remote computer operable to address the web site of the host and communicate across the network with the host.

33. The system of claim 23, in which the host and client stations are part of a single workstation.

34. A device to generate a clinical menu, comprising:
a processing unit;
a machine-readable storage medium to retain instructions for execution by the processing unit;
the machine-readable storage medium storing a sequence of instructions which, when processed by the processing unit, cause the processing unit to
receive a request from a client station; and
responsive to the request received, to exchange data with the client station to
configure an interactive web page,
determine a patient identity,
determine a dietitian identity to be associated with the patient identity, and
identify at least one operative to influence clinical menu generation.

35. The device of claim 34, in which the instructions of the machine-readable storage medium, comprise portions effective, when processed by the processing unit, to cause the device to prompt, via the interactive web page, a client for an operative comprising at least one of the group consisting of
edit a food database,
edit a clinical record of the patient,
generate a clinical menu for the patient,
proscribe a food item into the clinical record for the patient,
prescribe a food item into the clinical record for the patient,
record eating patterns of the patient, and
retrieve or update an existing menu of the patient; and
influence the selection of food items from the food database during generation of a clinical menu for the patient, the influence to be based on the clinical record for the patient.

36. The device of claim 35, further comprising:
a patient database networked to the client station to store clinical records associated with patient identities, the patient database accessible by the processing unit when processing requests of the client station;
a food database to retain nutritional information of a plurality of foods and accessible by the processing unit; and
a dietitian database to store information of dietitian identities accessible by the processing unit when processing requests of the client station.

37. The device of claim 36, the instructions of the machine-readable storage medium, when processed by the processing unit, further to cause it to be responsive to receipt of an operative to generate a clinical menu by
retrieving clinical criteria from the patient database based upon the patient identity determined,
selecting food items of the food database dependent on the clinical criteria retrieved for the individual; and
verifying that such selection of the food items conform with at least one of macro and micro nutritional guidelines and any prescribed and/or proscribed food items associated with the clinical criteria of the patient; and
using food items selected and verified to create the clinical menu.

38. The device of claim 36, in which the instructions further cause the processing unit to
examine information of the dietitian's records within the dietitian database and check for an existence of a dietitian-patient relationship between the dietitian identified and the patient identified; and
make selection of the operatives editing a food database, editing a clinical record of the patient, generating a clinical menu for the patient, and proscribing or prescribing a food item dependent upon the existence of such dietitian-patient relationship.

39. The device of claim 36, further comprising a dietitian station to display and operate a dietitian window,
the instructions of the machine-readable storage medium, when processed by the processing unit, further to cause it to be responsive to receipt of an operative to edit a clinical record by prompting a dietitian in a dietitian window of the dietitian station to obtain the patient's age, weight, height, gender, activities, anomalies, and allergies.

40. The device of claim 38, the instructions of the machine-readable storage medium, when processed by the processing unit, further to cause it to be responsive to the receipt of an edit operative, by
prompting the dietitian through the dietitian window to select at least one of
formulate a macro-nutritional objective in the clinical record for the patient,
formulate a micro-nutritional objective in the clinical record for the patient, and
enter an activity schedule of the patient to formulate a calorie budget in the clinical record for the patient.

41. A network device to interface a customer to a clinical menu station, comprising:
a process controller to control a process of at least one input/output device;
a machine readable storage medium in communication with the process controller to retain instructions to be executed by the process controller which, when executed thereby, cause the process controller to
present a window to the customer on a screen to query and determine a patient identity; and
index a database across the network using the patient identity;
obtain a clinical menu for the patient from the database associated with the patient identity; and
present the customer the clinical menu.

42. The device of claim 41, the instructions further to cause the process controller to prompt the customer in the window for a request consisting of at least one of the group of
exchange a food item, and
confirm menu receipt; and
determine a reply of the customer to the prompt.

43. The device of claim 42, the instructions further to cause the process controller to
query, responsive to an exchange request, a food database and determine possible replacement food items of nutritional make-up substantially equivalent to the food item requested for exchange;
verify which of the possible replacement food items determined meet clinical criteria of the patient associated with the clinical menu retrieved;
present such verified replacement food items to the patient for selection; and
determine a selection of the patient for one of the replacement food items presented.

44. The device of claim 43, the instructions further to cause the process controller to
update a record in a database associated with the patient identity to revise the clinical menu in accordance with the determined selection.

45. The device of claim 44, in which the update comprises sending data to a remote patient database to update, in accordance with the selection determined, eating pattern information for a record of the patient identity.

46. The device of claim 44, the instructions further to cause the process controller to send information to a remote patient database to update, in accordance with the selection determined, eating pattern records for the patient identified.

47. An article comprising:
a machine-readable medium having stored thereon a sequence of instructions which, when executed by a control processor, cause the control processor to
access a patient database to retrieve a clinical record of a patient; and
access a food database to identify a food item of the food database and determine nutritional elements of the food item identified;
determine nutritional guidelines from the clinical record retrieved; and
compare the nutritional elements determined for the identified food item to the nutritional guidelines determined for the patient; and
select, dependent on the comparison, the food item identified for incorporation into a clinical menu for the patient.

48. The article of claim 47, in which the instructions of the machine-readable storage medium when executed by the control processor further cause the control processor to
determine a correlation of the nutritional elements of the food item identified to the nutritional guidelines determined; and
make the selection of the food item dependent upon the correlation determined.
